(19) United States
(12) Patent Application Publication
(10) Pub. No.: US 2010/0259469 A1
(43) Pub. Date: Oct. 14, 2010

(54) LIQUID CRYSTAL DISPLAY PANEL AND LIQUID CRYSTAL DISPLAY DEVICE

(76) Inventors: Masahiro Shimizu, Osaka (JP); Takashi Katayama, Osaka (JP); Toshihiro Matsumoto, Osaka (JP); Tsuyoshi Okazaki, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/740,505

(22) PCT Filed: Jul. 11, 2008
(86) PCT No.: PCT/JP2008/062622

§ 371 Date: Apr. 29, 2010

(30) Foreign Application Priority Data
Nov. 2, 2007 (JP) 2007-286661

(51) Int. Cl. G09G 3/36

(52) U.S. Cl. 345/87

(57) ABSTRACT

A liquid crystal display panel (2) includes a TFT substrate (20) and a counter substrate (30) placed opposite each other via a liquid crystal layer (40) containing liquid crystal molecules (41) that, when an electric field is applied, makes an alignment transition from an initial state to an image display state different in state of alignment from the initial state. A region (40B) where the liquid crystal molecules come into anti-parallel alignment is provided in that region of at least either the TFT substrate (20) or the counter substrate (30) to which a transverse electric field parallel to a surface of the substrate is applied. This makes it possible to provide a liquid crystal display panel capable of causing each pixel to surely make an alignment transition and making a quick alignment transition from an initial state to an image display state in a liquid crystal layer.

### TECHNICAL FIELD

The present invention relates to an OCB (optically self-compensated birefringence) mode liquid crystal display panel and an OCB mode liquid crystal display device.

### BACKGROUND ART

Conventionally, a large number of color liquid crystal display devices have been used as color displays having such features as thin thickness and lightweight features. In recent years, owing to the development of liquid crystal technology, high-contrast color liquid crystal display devices with wide viewing angle characteristics have been developed, and they have been in wide practical use as the mainstream of large-sized displays.

At present, examples of widely-used color liquid crystal display devices include: those of the twisted-nematic mode (hereinafter referred to as “TN mode”) in which a display is carried out by controlling the optical rotation of a liquid crystal layer with an electric field; and those of the electrically controlled birefringence mode (hereinafter referred to as “ECB mode”) in which a display is carried out by controlling the birefringence of a liquid crystal layer with an electric field.

However, these modes of color liquid crystal display device are still so slow in response speed as to leave traces and/or blur contours and therefore ill-suited to displaying moving images.

Given this problem, a large number of conventional attempts have been made to increase the response speed of color liquid crystal display devices. At present, examples of liquid crystal modes with high-speed response suited to displaying moving images include the ferroelectric liquid crystal mode, the antiferroelectric liquid crystal mode, and the OCB (optically self-compensated birefringence) mode.

Among these liquid crystal modes, the ferroelectric liquid crystal mode and the antiferroelectric liquid crystal mode are known to have a bunch of problems with practical use because they have layered structures and therefore are weak in impact resistance.

Meanwhile, the OCB mode has drawn attention as a liquid crystal mode most suitable for displaying moving images because it uses ordinary nematic liquid crystals and therefore is strong to impact, wide in temperature range, viewable at wide angles, and high in response speed.

FIG. 16 is a cross-sectional view schematically showing a layer of liquid crystals in bend alignment in an OCB mode liquid crystal display device. FIG. 17 is a cross-sectional view schematically showing a layer of liquid crystals in splay alignment in an OCB mode liquid crystal display device.

As shown in FIGS. 16 and 17, an OCB mode liquid crystal display device is constituted by a pair of substrates 101 and 111 and a liquid crystal layer 121 sandwiched therebetween. Among the pair of substrates 101 and 111, one substrate 101 is constituted by a transparent substrate 102 such as a glass substrate, a transparent electrode 103 formed on the transparent substrate 102, and an alignment film 104 formed on the transparent electrode 103. On the other hand, the other substrate 111 is constituted by a transparent substrate 112 such as a glass substrate, a transparent electrode 113 formed on the transparent substrate 112, and an alignment film 114 formed on the transparent electrode 113. The alignment films 104 and 114 have their surfaces finished with alignment treatment by rubbing. The pair of substrates 101 and 111 are placed opposite each other so that each of the alignment films 104 and 114 faces the liquid crystal layer 121. The liquid crystal layer 121 is constituted by nematic liquid crystals.

For carrying out a color display in the liquid crystal display device, a color filter (not shown) is produced on either the transparent substrate 102 or 112. Further, for active-matrix driving of the liquid crystals, gate bus lines and source bus lines (both not shown) are formed on either the transparent substrate 102 or 112, and TFTs (thin-film transistors) are formed at intersections between the gate bus lines and the source bus lines. The substrates 101 and 111 thus formed are joined to each other with an appropriate gap provided therebetween by spherical or pillar-shaped spacers. The liquid crystals are injected and sealed in between the substrates 101 and 111 by either vacuum-injecting the liquid crystals between the substrates 101 and 111 joined to each other or injecting the liquid crystals in drops in joining the substrates 101 and 111 to each other. Thus formed is a liquid crystal cell in which the liquid crystal layer 121 is sandwiched between the substrates 101 and 111.

For improving the viewing angle characteristics of a display, the liquid crystal display device has a wave plate (viewing-angle-compensating wave plate; not shown) joined on one or each side of the liquid crystal cell and a polarizing plate (not shown) joined laterally to the wave plate.

Liquid crystal molecules 122 in the liquid crystal layer 121 are often aligned substantially parallel to the substrate surfaces, as shown in FIG. 17, immediately after the injection of the liquid crystals, and such a state is called initial alignment (splay alignment). When a desired voltage is applied to the transparent electrodes 103 and 113 provided with the liquid crystal layer 121 sandwiched therebetween, the liquid crystal layer 121 makes an alignment transition, thus changing sequentially to alignment shown in FIG. 16 (bend alignment). When such bend alignment as shown in FIG. 16, the liquid crystals respond quickly in an alignment change. For this reason, such a liquid crystal display device becomes capable of the quickest display among the modes in which nematic liquid crystals are used. Furthermore, such a combination with a wave plate as described above results in a state of display with wide viewing angle characteristics.

As mentioned above, the OCB mode is in splay alignment, as shown in FIG. 17, when no voltage is applied, and comes into bend alignment, as shown in FIG. 16, when a display such as a color display is actually carried out.

However, as shown in FIG. 18, when a drive voltage is suddenly applied to the liquid crystal layer 121 in the initial state, those liquid crystal molecules 122 close to the upper or lower substrate 101 or 111 rise along an electric field, but those liquid crystal molecules 122 in the midsection of the liquid crystal cell remain parallel to the substrates 101 and 111 and therefore do not come into bend alignment. For this reason, an alignment transition from splay alignment to bend alignment (splay-to-bend transition) is known to require a high voltage different from an ordinary drive voltage or a long time.

The period of time during which such a splay-to-bend transition is made across the whole region in the screen depends on the voltage that is applied to the liquid crystal layer 121. FIG. 19 shows a relationship between the applied voltage to the liquid crystal layer 121 and the splay-to-bend transition time at room temperature (25° C.).

In this example, the area of each of the transparent electrodes 103 and 113 was 1 cm², and the cell thickness (layer thickness of the liquid crystal layer 121) was 5 μm. As shown in FIG. 19, the higher the applied voltage to the liquid crystal layer 121 becomes, the shorter the splay-to-bend transition time becomes.

Meanwhile, observation of a splay-to-bend transition shows that the transition occurs from an unusual site where several spacers aggregate. Such a site is called a transition nucleus. Because only several transition nuclei are generated within a 1 cm² area, the period of time required for the splay-to-bend transition to spread across the whole region in the screen is lengthened. The speed at which the splay-to-bend transition spreads depends on the viscosity of the liquid crystals. For this reason, for example, at a low temperature of −30° C., the viscosity of the liquid crystals increases dramatically; therefore, the speed at which the splay-to-bend transition spreads becomes approximately 100 times as slow as the speed at which the splay-to-bend transition would spread at room temperature.

Furthermore, a TFT panel in which the TFTs are provided at the intersections between the gate bus lines and the source bus lines as described above has a pixel electrode formed in each region surrounded by source bus lines and gate bus lines that intersect with each other (the source bus lines and the gate bus lines being hereinafter collectively referred to simply as “bus lines”). Moreover, the TFT panel usually has a separating space provided between each pixel electrode and its corresponding bus lines to secure insulation between the pixel electrode and the bus lines.

In the separating space, neither the pixel electrode nor the bus lines exit; therefore, a voltage is hardly applied to the liquid crystal layer.

Thus, in the separating space where no voltage is applied to the liquid crystal layer, even if a splay-to-bend transition occurs at a transition nuclear in a certain pixel electrode, the splay-to-bend transition does not spread to an adjacent pixel beyond the separating space. This causes such a problem that a splay-to-bend transition having occurred in one pixel electrode does not spread to another pixel electrode that contains no transition nucleus and therefore does not spread across the whole region in the screen.

In Patent Literature 1, given this problem, a protrusion or depression made of a conducting material is formed in a predetermined position within the screen in order to facilitate generation of a transition nucleus. Such a configuration allows an electric field to be applied to the liquid crystal layer on the protrusion or depression at a higher intensity than to the surrounding area, thus facilitating generation of a transition nucleus. Production of such a transition nucleus in each pixel makes it possible to surely make a splay-to-bend transition.

Meanwhile, in Patent Literature 2, driving means, placed to overlap with a first electrode (e.g., auxiliary capacitor wire) via an insulator, which generates a potential difference with a second electrode (e.g., pixel electrode) having a missing portion is used in order to facilitate generation of a transition nucleus. Use of such driving means allows an electric field to be applied between the two electrodes at a higher intensity than in the other areas, and those liquid crystal molecules disposed around the missing portion serve as a transition nucleus. Therefore, in this case, too, it becomes possible to surely make a splay-to-bend transition.

In Patent Literatures 1 and 2, such a structure serving as a transition nucleus is formed in each pixel. For this reason, even if there exist a large number of separating spaces (gap between pixels), as in the case of a TFT panel, where no voltage is applied to the liquid crystal layer, a splay-to-bend transition can be spread to all pixels, i.e., to the whole screen.

### Citation List

Patent Literature 1

Japanese Patent Application Publication, Tokukaihei,

### No. 10-20284 A (Publication Date: Jan. 23, 1998)

Patent Literature 2

Japanese Patent Application Publication, Tokukai, No. 2003-107506 A (Publication Date: Apr. 9, 2003) (Corresponding US Patent Application Publication No. 2002/145579 (Publication Data: Oct. 10, 2002))

Patent Literature 3

Japanese Patent Application Publication, Tokukai, No. 2003-202575 A (Publication Date: Jul. 18, 2003) (Corresponding US Patent Application Publication No. 2004/246421 (Publication Data: Dec. 9, 2004))

### SUMMARY OF INVENTION

However, in the configuration of Patent Literature 1, a splay-to-bend transition does not necessarily occur in each protrusion or depression in some operation environments for liquid crystal displays. Similarly, in the configuration of Patent Literature 2, a splay-to-bend transition does not necessarily occur in each missing portion in some operation environments for liquid crystal displays. For example, at a low temperature of −30° C. or so, the viscosity of the liquid crystals is so high that the time required for a splay-to-bend transition is lengthened. Therefore, in some cases, no transition nucleus is generated before a desired display is carried out, with the result that no splay-to-bend transition takes place.

A pixel that is not in bend alignment becomes a bright dot and therefore is observed as a point defect. For this reason, when no transition nucleus is generated in all pixels, a pixel where no transition nucleus is generated cannot be brought into bend alignment without waiting for the spread of a splay-to-bend transition having occurred from another pixel. This causes an increase in the period of time between turning on power and coming into a display state. Further, when a pixel electrode is disconnected from its corresponding bus lines by a separating space as described above, a splay-to-bend transition having occurred from a transition nucleus in a certain pixel cannot spread to another pixel. In this case, a pixel where no transition nucleus has been generated does not come into bend alignment.

The present invention has been made in view of the foregoing problems, and, it is an object of the present invention to provide a liquid crystal display panel and a liquid crystal display device that are capable of both causing each pixel to surely make an alignment transition and making a quick alignment transition from an initial state to an image display state in a liquid crystal layer.

A liquid crystal display panel for solving the foregoing problems is a liquid crystal display panel including a pair of substrates placed opposite each other via a liquid crystal layer containing liquid crystal molecules that, when an electric field is applied, makes an alignment transition from an initial state to an image display state different in state of alignment from the initial state, in that region of at least either of the pair of substrates to which a transverse electric field parallel to the substrate is applied, a region where the liquid crystal molecules come into anti-parallel alignment (i.e., align themselves in a direction parallel and opposite to a pre-tilt direction of the liquid crystal molecules, i.e., to a direction of alignment treatment of the substrate) being provided.

Further, a liquid crystal display device includes such a liquid crystal display panel as described above.

According to the foregoing configurations, there appear no liquid crystal molecules parallel to a substrate surface of the substrate, whereby the alignment transition (esp., a splay-to-bend transition) from the initial state (splay alignment) to the image display state (bend alignment or π twist alignment, which is a more stable state) in the liquid crystal layer spreads across the whole of each pixel with the anti-parallel alignment of liquid crystal molecules serving as a transition nucleus. Therefore, the alignment transition can be made quickly even at such an extremely low temperature of −30° C. Thus, the foregoing configurations make it possible to provide a liquid crystal display panel and a liquid crystal display device that are capable of both causing each pixel to surely make an alignment transition and making a quick alignment transition from an initial state to an image display state in a liquid crystal layer.

### BRIEF DESCRIPTION OF DRAWINGS

FIG. 1

FIG. 1 is a cross-sectional view schematically showing the configuration of a liquid crystal display panel in a liquid crystal display device according to an embodiment of the present invention in the vicinity of an opening provided in an area of overlap between a pixel electrode and a storage capacitor bus line of the liquid crystal display panel, together with the alignment of liquid crystals as observed when no voltage is applied.

FIG. 2

FIG. 2 is a plan view schematically showing the configuration of a pixel of the liquid crystal display panel in the liquid crystal display device according to the embodiment of the present invention and the area around the pixel.

FIG. 3

FIG. 3 is a block diagram schematically showing the configuration of the liquid crystal display device according the embodiment of the present invention.

FIG. 4

FIG. 4 is a cross-sectional view schematically showing the configuration of the liquid crystal display panel of FIG. 1 in the vicinity of a TFT of the liquid crystal display panel.

FIG. 5

FIG. 5 is a cross-sectional view schematically showing another example of the configuration of the liquid crystal display panel of FIG. 1 in the vicinity of a TFT of the liquid crystal display panel.

FIG. 6

FIG. 6 is a cross-sectional view schematically showing the configuration of the liquid crystal display panel in the liquid crystal display device according to the embodiment of the present invention in the vicinity of the opening provided in the area of overlap between the pixel electrode and the storage capacitor bus line of the liquid crystal display panel, together with the alignment of liquid crystals as observed when a voltage is applied.

FIG. 7

FIG. 7 is a graph showing a state of alignment that is observed when a voltage is applied to the pixel electrode, bus line, and counter electrode of the liquid crystal display panel of FIG. 1 with use of simulation software.

FIG. 8

FIG. 8 includes plan views (a) through (i) each schematically showing an example of the shapes of such openings as shown in FIG. 1.

FIG. 9

FIG. 9 is a plan view showing the appearance of an electric field that is generated in the opening in the insulating film of (a) of FIG. 8 from the storage capacitor bus line to the pixel electrode through the opening in the pixel electrode.

FIG. 10

FIG. 10 is a cross-sectional view schematically showing the configuration of a comparative liquid crystal display panel in the vicinity of an opening provided in an area of overlap between a pixel electrode and a storage capacitor bus line of the comparative liquid crystal display panel, together with the alignment of liquid crystals as observed when no voltage is applied, the comparative liquid crystal display device including a TFT substrate having no interlayer insulating film provided between the bus line and the pixel electrode.

FIG. 11

FIG. 11 is a cross-sectional view schematically showing the configuration of the comparative liquid crystal display panel of FIG. 10 in the vicinity of the opening provided in the area of overlap between the pixel electrode and the storage capacitor bus line of the comparative liquid crystal display panel, together with the alignment of liquid crystals as observed when a voltage is applied.

FIG. 12

FIG. 12 is a graph showing a state of alignment that is observed when a voltage is applied to the pixel electrode, bus line, and counter electrode of the liquid crystal display panel of FIG. 10 with use of simulation software.

FIG. 13

FIG. 13 is a cross-sectional view schematically showing the configuration of a comparative liquid crystal display panel in the vicinity of an opening provided in an area of overlap between a pixel electrode and a storage capacitor bus line of the comparative liquid crystal display panel, together with the alignment of liquid crystals as observed when no voltage is applied, the comparative liquid crystal display device including a TFT substrate having no opening provided in the pixel electrode.

FIG. 14

FIG. 14 is a cross-sectional view schematically showing the configuration of the comparative liquid crystal display panel of FIG. 13 in the vicinity of the opening provided in the area of overlap between the pixel electrode and the storage capacitor bus line of the comparative liquid crystal display panel, together with the alignment of liquid crystals as observed when a voltage is applied.

FIG. 15

FIG. 15 is a graph showing a state of alignment that is observed when a voltage is applied to the pixel electrode, bus line, and counter electrode of the liquid crystal display panel of FIG. 13 with use of simulation software.

FIG. 16

FIG. 16 is a cross-sectional view schematically showing a layer of liquid crystals in bend alignment in an OCB mode liquid crystal display device.

FIG. 17

FIG. 17 is a cross-sectional view schematically showing a layer of liquid crystals in splay alignment in an OCB mode liquid conventional crystal display device.

FIG. 18

FIG. 18 is a cross-sectional view schematically showing the alignment of liquid crystals as observed when a voltage is applied to a layer of liquid crystals in an initial state in a conventional OCB mode liquid crystal display device.

FIG. 19

FIG. 19 is a graph showing a relationship between the applied voltage to the liquid crystal layer and the splay-to-bend transition time at room temperature in a conventional OCB mode liquid crystal display device.

### REFERENCE SIGNS LIST

1 Liquid crystal display device
2 Liquid crystal display panel
3 Control circuit
4 Gate driver circuit
5 Source driver circuit
6 Cs driver circuit
10 Pixel
11 Gate bus line
12 Source bus line
13 TFT
14 Gate electrode
15 Insulating film (gate insulating film)
16 Semiconductor layer
17 Source electrode
18 Drain electrode
19 Insulating film (protective film)
20 TFT substrate (first substrate)
21 Transparent substrate
22 Cs bus line
23 Insulating film (interlayer insulating film)
23A Opening
23B Inclined portion (inclined plane, step portion)
23C Inclined portion
24 Pixel electrode (second electrode)
24A Opening
24B Inclined portion (inclined plane, step portion)
24C Inclined portion (inclined plane, step portion)
24D Fringe portion (flat portion)
25 Alignment film
25B Inclined portion
25C Inclined portion
26 Region
26A Bent portion
30 Counter substrate (second substrate)
31 Transparent substrate
32 Counter electrode
33 Alignment film
40 Liquid crystal layer
40B Region
41 Liquid crystal molecule
41A Liquid crystal molecule
50 TFT substrate
60 TFT substrate
61 Pixel electrode

### DESCRIPTION OF EMBODIMENTS

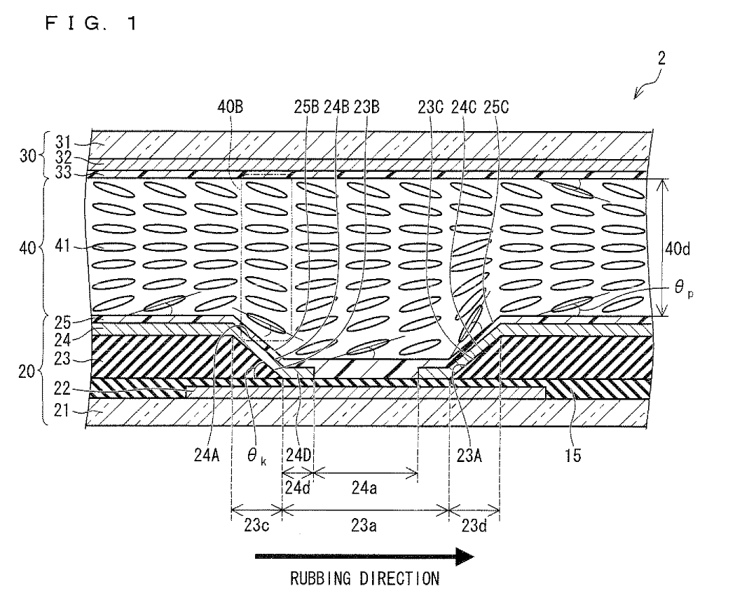

An embodiment of the present invention is described below with reference to FIGS. 1 through 15.

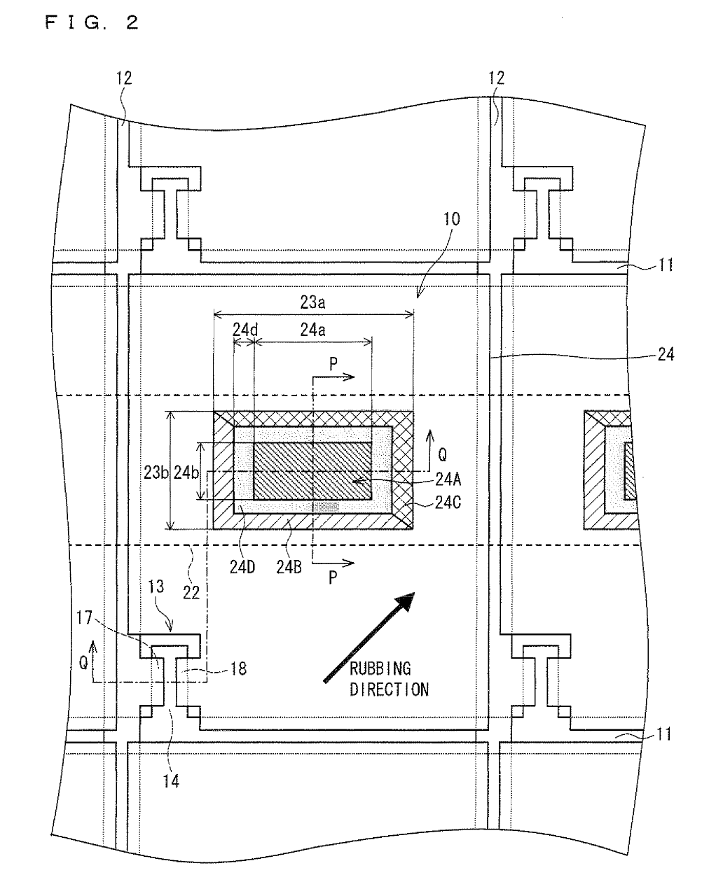

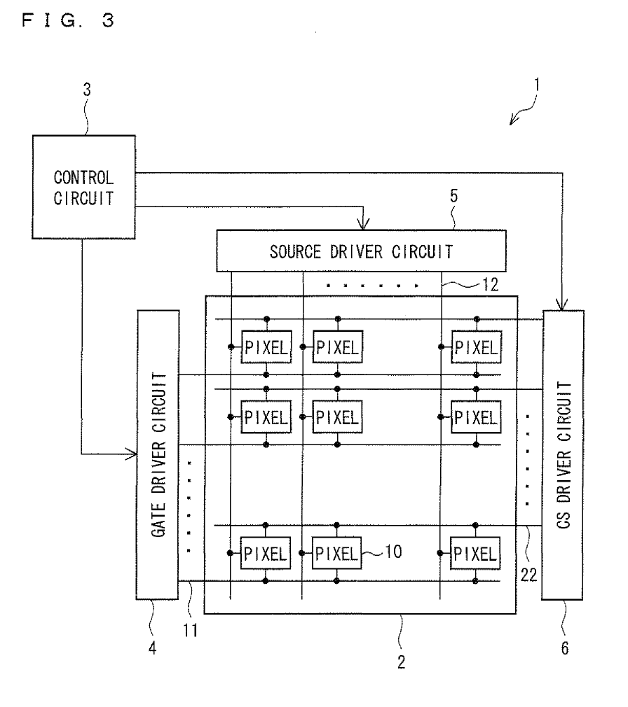

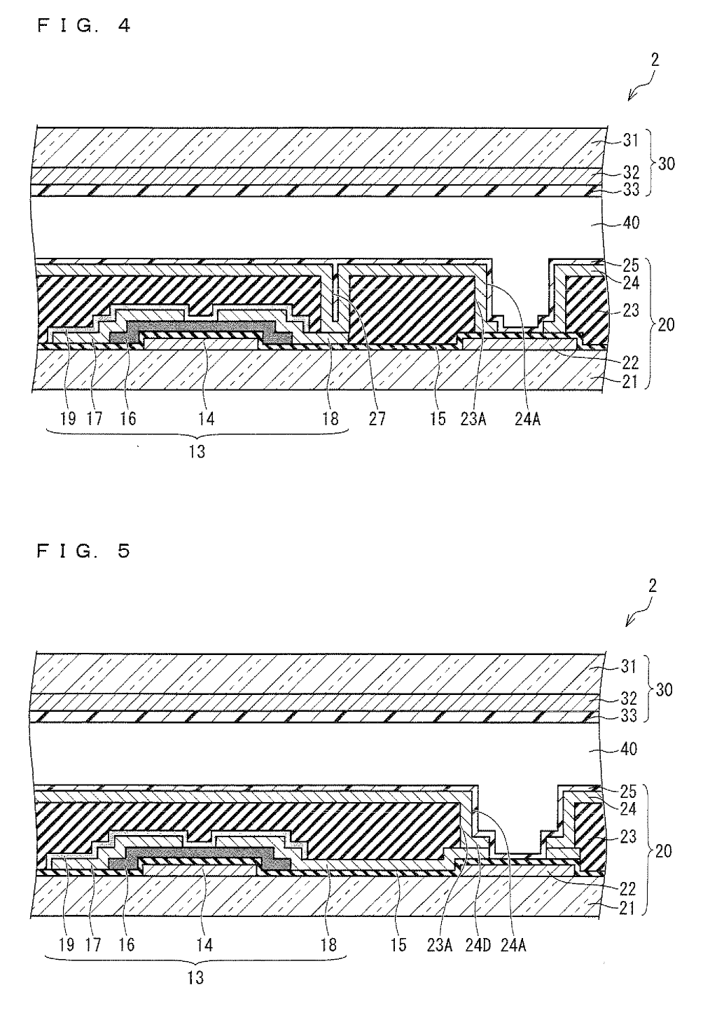

FIG. 1 is a cross-sectional view schematically showing the configuration of a liquid crystal display panel in a liquid crystal display device according to the present embodiment in the vicinity of an opening provided in an area of overlap between a pixel electrode and a storage capacitor bus line of the liquid crystal display panel, together with the alignment of liquid crystals as observed when no voltage is applied; FIG. 2 is a plan view schematically showing the configuration of a pixel of the liquid crystal display panel in the liquid crystal display device according to the present embodiment and the area around the pixel. Further, FIG. 3 is a block diagram schematically showing the configuration of the liquid crystal display device according the present embodiment; FIG. 4 is a cross-sectional view schematically showing the configuration of the liquid crystal display panel of FIG. 1 in the vicinity of a TFT (thin-film transistor) of the liquid crystal display panel. It should be noted that FIG. 1 is equivalent to a cross-sectional view of the liquid crystal display panel as taken from line P-P of FIG. 2 and FIG. 4 is equivalent to a cross-sectional view of the liquid crystal display panel as taken from line Q-Q of FIG. 2. For convenience of illustration, FIG. 2 omits to illustrate a counter substrate or an alignment film of a TFT substrate.

As shown in FIG. 3, a liquid crystal display device 1 according to the present embodiment includes a liquid crystal display panel 2, a driving circuit for driving the liquid crystal display panel 2, a control circuit 3 for controlling driving of the driving circuit, and, as needed, a backlight unit (not shown).

Further, the driving circuit includes a gate driver circuit 4, a source driver circuit 5, and a Cs driver circuit 6 for driving gate bus lines 11, source bus lines 12, and storage capacitor bus lines (hereinafter referred to a “Cs bus lines”) 22, respectively, provided in the liquid crystal display panel 2.

The gate driver circuit 4, the source driver circuit 5, and the Cs driver circuit 6 are electrically connected to the gate bus lines 11, the source bus lines 12, and the Cs bus lines 22, respectively, and these bus lines can be independently fed with potentials from outside. Each of these driver circuits is electrically connected to the control circuit 3, and is controlled by a control signal and a video signal that are supplied from the control circuit 3.

As shown in FIGS. 2 and 3, the gate bus lines 11 and the source bus lines 12 are provided in such a way as to intersect with (to be orthogonal to) each other. Each region surrounded by its corresponding gate bus lines 11 and its corresponding source bus lines 12 constitutes a single pixel. The liquid crystal display panel 2 is constituted by a plurality of such pixels 10 arranged in a matrix manner.

As shown in FIG. 2, each of the pixels 10 is provided with a pixel electrode 24. Further, each of the pixels 10 has a TFT 13 provided as an active element (switching element) at an intersection between its corresponding gate bus line 11 and its corresponding source bus line 12.

As shown in FIG. 4, the TFT 13 is constituted by a transparent substrate 21 (transparent insulating substrate) such as a glass substrate, a gate electrode 14 formed on the transparent substrate 21, an insulating film 15 provided on the gate electrode 14 as a gate insulating film, a semiconductor layer 16 formed on the insulating film 15, a source electrode 17 formed on the semiconductor layer 16, and a drain electrode 18 formed on the semiconductor layer. Further, the TFT 13 has an insulating film 19 formed thereon as a protective film.

As shown in FIG. 2, the gate electrode 14 of the TFT 13 is electrically connected to the gate bus line 11. Further, the source electrode 17 of the TFT 13 is electrically connected to the source bus line 12. Furthermore, as shown in FIG. 4, the drain electrode 18 of the TFT 13 is electrically connected to the pixel electrode 24 through a contact hole 27. It should be noted that these components do not differ greatly from their conventional counterparts, and as such, are not detailed here.

Furthermore, the Cs bus lines 22 are provided on the same level as the gate bus lines 11 in such a way as to extend through the center of each of their corresponding pixels 10 substantially parallel to the gate bus lines 11. According to the present embodiment, the potential of each pixel can be stabilized by a storage capacitance that is formed between its corresponding Cs bus line 22 and its corresponding pixel electrode 24.

The insulating film 15 of FIG. 4 is formed between the gate bus lines 11 and the source bus lines 12. Formed as an interlayer insulating film between the source bus lines 12 and the pixel electrodes 24 is an insulating film 23 shown in FIG. 4. Formed on the pixel electrodes 24 is an alignment film 25 as shown in FIG. 4.

The pixel electrodes 24 are formed in such a way as to overlap flatways with the gate bus lines 11, the source bus lines 12, and the Cs bus lines 22 via the insulating films 15 and 23. That is, in the liquid crystal display panel 2, as shown in FIG. 2, the pixel electrodes 24 are disposed to overlap with the bus lines as the liquid crystal display panel 2 is viewed from its display surface, in order that no separating space is created between each of the pixel electrodes 24 and its corresponding bus lines.

Further, each of the pixel electrodes 24 has an opening 24A (missing portion) provided in a part of that region of the pixel electrode 24 which overlaps with its corresponding Cs bus line 22.

The following describes a cross-sectional structure of the liquid crystal display panel 2.

As described above, the liquid crystal display panel 2 is a TFT liquid crystal display panel. As shown in FIG. 1, the liquid crystal display panel 2 is constituted by a TFT substrate 20 (first substrate, TFT array substrate) and a counter substrate 30 (second substrate, color filter substrate) with a liquid crystal layer 40 sandwiched between the pair of substrates.

The liquid crystal display panel 2 has a wave plate (not shown) joined, as needed, to at least one of the substrates laterally to the pair of substrates (on those surfaces of the substrates which face away from each other) and polarizing plates (not shown) joined laterally to the wave plate or the substrates. It should be noted that the polarizing plates, provided laterally to the pair of substrates, respectively, are disposed to have a crossed nicols relationship with each other.

Among the pair of substrates, the counter substrate 30 is constituted by a transparent substrate 31 (transparent insulating substrate) such as a glass substrate, a counter electrode 32 formed on the surface of the transparent substrate 31 which faces toward the TFT substrate 20, and an alignment film 33 formed on the counter electrode 32. Further, the transparent substrate 31 may be provided, as needed, with functional films (not shown) such as an undercoat layer (foundation film), a color filter layer, and an overcoat layer (planarizing layer).

The counter electrode 32 is formed substantially entirely on that surface of the transparent substrate 31 that faces toward the TFT substrate 20, and is used as an electrode (common electrode) common to all pixels 10. When an electric field is applied to the liquid crystal layer 40 by a voltage applied to the counter electrode 32 and the pixel electrode 24, an image is formed.

On the other hand, as shown in FIGS. 1 and 4, the TFT substrate 20 is configured such that (i) a first metal electrode constituted by the gate bus lines 11, the Cs bus lines 22, and the like shown in FIG. 2, (ii) the insulating film 15 (gate insulating film, first interlayer insulating film), (iii) a second metal electrode layer constituted by the source bus lines 12, the source electrodes 17, the drain electrodes 18, and the like, (iv) the insulating film 23 (second interlayer insulating film), (v) the pixel electrodes 24, and (vi) the alignment film 25 are stacked in this order on the transparent substrate 21 (transparent insulating substrate 21) such a glass substrate.

The alignment films 25 and 33, provided on those surfaces of the TFT substrate 20 and the counter electrode which interface with the liquid crystal layer 40, respectively, are so-called horizontal alignment films that align liquid crystal molecules 41 in the liquid crystal layer 40 parallel (horizontally) to the substrate surfaces of the transparent substrates 21 and 31 when no voltage is applied. This allows the liquid crystal molecules 41 in the liquid crystal display panel 2 to be kept in a state of splay alignment when no electric field is applied.

Further, the opening 24A, provided in the pixel electrode 24 (second electrode) placed to overlap with the Cs bus line 22 (Cs electrode, first electrode) via at least the insulating film 15, functions as transition nucleus generating means for generating a splay-to-bend transition. In the present embodiment, the insulating film 23, provided between the insulating film 15 and the pixel electrode 24, has openings 23A provided in such positions as to overlap with the Cs bus lines 22.

Each of the openings 23A has its peripheral wall inclined as shown in FIG. 1, and the opening 24A in the pixel electrode 24 is formed in such a way that the pixel electrode 24 covers the peripheral wall (inclined plane) of the opening 23A in the insulating film 23.

In this way, the opening 24A in the pixel electrode 24 is provided inside of the opening 23A in the insulating film 23, provided between the insulating film 15 covering the Cs bus line 22 and the pixel electrode 24, in such a way that the pixel electrode 24 covers the peripheral wall of the opening 23A. Accordingly, the pixel electrode 24 has a step portion provided in a region adjacent to the opening 24A in the pixel electrode 24, i.e., in the area around the opening 24A on the basis of a step of the insulating film 23 as formed by making an opening in the insulating film 23, in such a way that the step portion serves as at least a part of the peripheral wall of the opening 24A.

It should be noted that the present embodiment is configured such that a part of the inclined plane based on a place where the step portions of the insulating film 23 and the pixel electrode 24 (peripheral walls of the openings 23A and 24A) and the step portion of the alignment film 25 covering the pixel electrode 24 are low in height ascends in a direction opposite to the rubbing direction of the alignment film 25.

In FIGS. 1 and 2, the inclined portion 23B and the inclined portion 24B indicate those portions (planes) of the peripheral walls (inclined planes) of the openings 23A and 24A which are inclined from lower to higher parts of the steps in a direction opposite to the rubbing direction of the alignment film 25, respectively, and the inclined portions 23C and 24C indicate those portions (planes) of the peripheral walls (inclined planes) of the openings 23A and 24A which are inclined from lower to higher parts of the steps in the same direction as the rubbing direction of the alignment film 25, respectively. Further, the inclined portion 25B indicates that portion (plane) of the step portion (inclined plane) of the alignment film 25 which is inclined from a lower to higher part of the step in a direction opposite to the rubbing direction, and the inclined portion 25C indicates that portion (plane) of the step portion (inclined plane) of the alignment film 25 which is inclined from a lower to higher part of the step in the same direction as the rubbing direction.

In the liquid crystal display panel 2, when a voltage is applied between the pixel electrode 24 and the counter electrode 32 and a potential difference is supplied between the Cs bus line 22 and the pixel electrode 24, an electric field generated between the Cs bus line 22 and the pixel electrode 24 springs out into the liquid crystal layer 40 through the opening 24A. That is, an equipotential line in the liquid crystal layer 40 bends, and an electric field in the vicinity of the opening 24A comes to have a component parallel to the substrate surfaces. In this way, the transverse electric field (springing-out electric field) generated in the opening 24A brings the liquid crystal molecules 41 into twist alignment. This result in the generation of a transition nucleus in each pixel 10, and a region occupied by those liquid crystal molecules 41 brought into bend alignment spreads from this transition nucleus across the whole pixel region, whereby a splay-to-bend transition is facilitated in each pixel 10.

It should be noted here, according to the present embodiment, that since the pixel electrode 24 has its step portions (inclined portions 24B and 24C) provided next to the opening 24A on the basis of step portions (inclined portions 23B and 23C) of the insulating film 23 under the pixel electrode 24 and those inclined planes (inclined portions 23B and 24B) based on a place where these step portions are low in height ascend, as described above, in a direction opposite to the rubbing direction, the alignment of liquid crystals in these step portions, i.e., the alignment of liquid crystal molecules 41 adjacent to that step portion (inclined portion 25B) of the alignment film 25 which covers the inclined portion 24B partially becomes anti-parallel alignment. That is, the liquid crystal molecules 41 become aligned parallel to and in a direction opposite to the pre-tilt direction of the liquid crystal molecules 41 (in other words, the alignment treatment direction of the TFT substrate 20). For this reason, there appear no liquid crystal molecules 41 parallel to the substrate surfaces.

In the present embodiment, a splay-to-bend transition can spread across the whole of each pixel 10 with the anti-parallel alignment of liquid crystals serving as a nucleus. Therefore, an alignment transition from an initial state (splay alignment) to an image display state (bend alignment or π twist alignment, which is a more stable state) in the liquid crystal layer 40 can be made more quickly.

It should be noted that there is less of an energy barrier between π twist alignment and bend alignment. It has already been known conventionally that as long as there is a transition from splay alignment to either π twist alignment or bend alignment, all regions are brought into bend alignment by carrying out display driving and become capable of a display.

In the present embodiment, it is preferable that the angle of inclination of each of the incline planes (step portions) of the openings 23A and 24A be, albeit not limited to, larger than the pre-tilt angle of the liquid crystal molecules 41 (or, in particular, that the angle of inclination of each of the inclined planes based on a place where the step portions are low in height be larger than the pre-tilt angle), because such an angle of inclination makes it easy for the alignment of liquid crystals to be anti-parallel alignment so that an alignment transition can be made more quickly.

In the present embodiment, it is preferable that the pre-tilt angle of the liquid crystal molecules 41 be not less than 2 degrees for the purpose of achieving stable bend alignment and not more than 45 degrees for the purpose of achieving high contrast in a black and white display. Further, in order to obtain such a configuration, it is preferable that the angle of inclination of the inclined plane (esp., the inclined portion 23B) of the insulating film 23 be not less than 4 degrees and not more than 90 degrees, and it is preferable that the film thickness of the insulating film 23 be not less than 0.1 μm for the purpose of securing insulation and not more than 10 μm from the point of view of patterning accuracy. Further, it is preferable that the widths 23c and 23d of the inclined plane (inclined portions 23B and 23C) of the insulating film 23 as viewed from a direction perpendicular to the TFT substrate 20, i.e., the distance between an open end of the opening 23A and a flat portion of the insulating film 23 as viewed from a direction perpendicular to the TFT substrate 20 be not less than 1 μm, where anti-parallel alignment can stably exist, and not more than the cell thickness, at or above which an electric field becomes unable to exert an influence.

Furthermore, it is preferable that the thickness of the insulating film 15 be not less than 0.1 μm for the purpose of securing insulation between the pixel electrode 24 and the Cs bus line 22 inside of the opening 23A in the insulating film 23 and not more than 10 μm from the point of view of patterning accuracy.

Further, the step portions or, in particular, the inclined portions 23B and 24B based on a place where the step portions are low in height are provided so that their distances from the opening 24A are shorter than the cell thickness 40d (thickness of the liquid crystal layer 40). This makes it easy to attain anti-parallel alignment in the inclined portions 23B and 24B (to be more exact, that inclined portion 25B of the alignment film 25 which covers the inclined portions 23B and 24B) when a voltage is applied to the pixel electrode 24, so that an alignment transition can be made more quickly.

The following describes an Example of Manufacture (Example) of such a liquid crystal display panel 2 as described above.

### Example of Manufacture

Steps in production of the TFT substrate 20 are described. First, the gate bus lines 11 and the Cs bus lines 22 are produced on the transparent substrate 21 such as a glass substrate finished in advance with treatment such as base coat. The gate bus lines 11 and the Cs bus lines 22 are produced by forming a metal film substantially entirely on one main surface of the transparent substrate 21 by sputtering and then pattering the metal film in a photolithographic step. The gate bus lines 11 and the Cs bus lines 22 thus produced have, but do not need to be, a laminated structure of tantalum (Ta) and a nitride thereof, and may be made of a metal such as titanium (Ti) or aluminum (Al) or ITO (indium tin oxide).

After that, the surfaces of the gate bus lines 11 and the Cs bus lines 22 are anodized (not shown), and then the insulating film 15 is formed from silicon nitride or the like.

Next, the semiconductor layer of each TFT 13 is formed by a CVD (chemical vapor deposition) method and patterned in a photolithographic step. Next, the source bus lines 12 and the drain electrode of each TFT 13 are formed in a similar manner to the gate bus lines 11 and the Cs bus lines, i.e., by forming a metal film by sputtering and then patterning the metal film in a photolithographic step. The source bus lines 12 are made of the same material as the gat bus lines 11 and the Cs bus lines 22, i.e., of a metal such as Ta, Ti, or Al.

Finally, the TFTs 13 are covered by the insulating film 19 (protective film) so that diffusion of impurities into the TFTs 13 is prevented and the performance of the semiconductor is enhanced. In this way, the bus lines and TFTs 13 of the TFT substrate 20 are produced.

Next, the insulating film 23 (interlayer insulating film) is produced on the bus lines and the TFTs 13 with use of a photoresist made of a polymeric material. Specifically, the photoresist is applied onto the bus lines and the TFTs 13 by spin coating, and then exposed and developed so that the contact holes 27 for conduction with the drain electrodes of the TFTs 13 are produced on the drain electrodes, respectively. At the same time, the photoresist is exposed and developed so that the openings 23A (missing portions) in the insulating film 23 are produced on the Cs bus line 22. After that, the photoresist is cured through calcination in an oven heated to approximately 180° C., whereby the insulating film 23 having the openings 23A is produced. In the present example, the film thickness of the insulating film 23 after curing was 3 μm on an average.

The present example uses a positive photoresist as the photoresist; therefore, the photoresist sagged with heat through calcination, with the result that the peripheral wall of each opening 23A in the insulating film 23 did not have a vertical cross-section but had an inclined cross-section as shown in FIGS. 1 and 2.

The angle of each inclined plane (inclined portion) around the opening 23A, i.e., the angle of inclination of the inclined portions 23B and 23C was substantially 45 degrees, which is sufficiently larger than the after-mentioned pre-tilt angle of the liquid crystals. In the present example, such a shape was formed by using a positive photoresist for the insulating film 23, but may be formed by using a negative photoresist.

Next, the pixel electrodes 24 are formed on the insulating film 23 by forming a metal film by sputtering and then patterning the metal film in a photolithographic step. Further, through this patterning, the openings 24A are produced at the same time as the pixel pattern is produced.

As shown in FIGS. 1, 2, and 4, each of the pixel electrodes 24 has a flat fringe portion 24D (flat portion, frame region) provided inside of the opening 23A in the insulating film 23 in such a way as to extend along the edge of the opening 24A in the pixel electrode 24. That is, that portion of the pixel electrode 24 which extends from the edge (open end) of the opening 24A in the pixel electrode 24 to the edge (open end) of the opening 23A in the insulating film 23 is in contact with the insulating film 15 under the insulating film 23 and parallel to a layer surface of the insulating film 15. The pixel electrode 24 has flat parts (flat portions) at both lower and upper sides of the inclined planes.

In the present example, the width 24d of the fringe portion 24D, i.e., the distance between the end of the opening 24A in the pixel electrode 24 and the end of the opening 23A in the insulating film 23 (i.e., in the inclined portions 23B and 24B based on a place (reference position) where the step portions are low in height, the distance between the reference position and the open end of the opening 24A as viewed from a direction perpendicular to the substrate surface) was approximately 1 μm. However, the width 24d may be wider or narrower than 1 μm as long as it is smaller than the cell thickness 40d. Further, the fringe portion 24D does not necessarily need to be provided. Since the width 24d of the fringe portion 24D is smaller than the cell thickness 40d as described above, it is easy for the alignment of liquid crystals in the inclined portions 23B and 24B to be anti-parallel alignment, as mentioned above, so that an alignment transition can be made more quickly.

In the present example, the film thickness of the insulating film 23 was 3 μm; the film thickness of each pixel electrode 24 was 140 nm; the lengths 23a and 23b of each opening 23A along the major and minor axes in FIGS. 1 and 2 were 41 μm and 26 μm, respectively; and the lengths 24a and 24b of each opening 24A along the major and minor axes in FIGS. 1 and 2 were 28 μm and 20 μm, respectively. Further, the widths 23c and 23d of the inclined planes (inclined portions 23B and 23C) of the insulating film 23 as viewed from a direction perpendicular to the TFT substrate 20 were 3 μm. Further, the cell thickness 40d as attained when the TFT substrate 20 was placed opposite the counter substrate 30 as described later was 7 μm.

Although the pixel electrode 24 was made of ITO as a transparent electrode, the pixel electrode 24 may be made of any electrode material as long as it is a thin-film conducting substance having transparency. Other than ITO, examples of such substances include IZO (indium zinc oxide). Further, when the liquid crystal display device 1 is formed as a reflective liquid crystal display device, the pixel electrode 24 may be made of a reflective thin-film conducting substance such as aluminum (Al) or silver (Ag) instead of being made of ITO or the like as a transparent electrode.

Further, in the present example, a contact hole 27 was made in each pixel 10, as shown in FIG. 4, so that the drain electrode 18 and the pixel electrode 24 are brought into contact. However, the present embodiment is not limited to this.

FIG. 5 is a cross-sectional view schematically showing another example of the configuration of the liquid crystal display panel of FIG. 1 in the vicinity of a TFT of the liquid crystal display panel. It should be noted that FIG. 5 is also equivalent to a cross-sectional view of the liquid crystal display panel as taken from line Q-Q of FIG. 2.

According to the present embodiment, as shown in FIG. 5, the fringe portion 24D is provided inside of the opening 23A in the insulating film 23, and the drain electrode 18 is extended to the opening 23A in the insulating film 23 so as to make contact with the fringe portion 24D, so that the drain electrode 18 and the pixel electrode 24 can be brought into contact without forming a contact hole 27 separately as shown in FIG. 4. In this case, it is not necessary to form a contact hole 27 separately as shown in FIG. 4 in a region different from the opening 23A (i.e., in another place inside of the pixel 10); therefore, the aperture ratio of the pixel 10 can be increased. Further, such an increase in aperture ratio of the pixel 10 leads to improvement in panel transmittance and suppression in amount of light of the backlight, thus enabling lower power consumption.

Next, steps in production of the counter substrate 30 are described. First, a black matrix (not shown) that separates one pixel 10 from another and RGB (red, green, blue) color filters (not shown) are produced on the transparent substrate 30 such as a glass substrate in a stripe array. After that, the counter electrode 32 was formed by forming a transparent electrode from ITO substantially entirely on one main surface of the transparent substrate 31 by sputtering.

Next, the TFT substrate 20 and the counter substrate 30 are subjected to alignment treatment by which the liquid crystal molecules 41 are aligned. First, the alignment films 25 and 33 are formed on the respective surfaces of the TFT substrate 20 and the counter substrate 30 by printing a parallel alignment polyimide on each of the substrates and calcining it in an oven, for example, at 200° C. for one hour. In the present example, the thickness of the alignment films 25 and 33 after calcination was approximately 100 nm.

Next, the surfaces of the alignment films 25 and 33 are rubbed with cotton cloth in one direction so that their alignment directions are parallel to each other when the TFT substrate 20 and the counter substrate 30 are joined. In the present example, the surfaces of the alignment films 25 and 33 were rubbed in the direction of an arrow shown in FIGS. 1 and 2.

It should be noted that the pre-tilt angle of the liquid crystals after rubbing cannot be directly measured. For this reason, in the present example, an 50-μm-thick anti-parallel alignment cell rubbed in directions parallel to but opposite to each other was produced separately, and the pre-tilt angle of the liquid crystals after rubbing was measured by a crystal rotation method. As a result, it was found that the pre-tilt angle of the liquid crystals after rubbing in the present example was approximately 8 degrees.

After that, the substrates are joined by dry-spraying moderate quantities of plastic spacers 7 μm in diameter onto the TFT substrate 20, printing a sealing agent around the screen of the counter substrate 30, and positioning the substrates. The sealing agent, which is a thermosetting resin, is calcined, for example, for 1.5 hours in an oven heated to 170° C. After that, a liquid crystal cell for use in the liquid crystal display panel 2 according to the present embodiment can be produced by injecting liquid crystals, for example, by using a liquid crystal filling vacuum injection method.

Further, in the present example, for wider viewing angles, wave plates (viewing-angle-compensating wave plates; not shown) were joined laterally to the liquid crystal cell, i.e., on those surfaces of the TFT substrate 20 and the counter substrate 30 which face away from each other, and polarizing plates (not shown) were joined laterally to the wave plates so that their absorption axes are orthogonal to each other, whereby the liquid crystal display panel 2 according to the present embodiment was produced.

Next, the splay-to-bend transition characteristics of the liquid crystal cell of the liquid crystal display panel 2 produced by the above method were evaluated.

First, a voltage of 10 V was applied to the liquid crystal layer 40 by inputting a signal of 0 V to the pixel electrode 24 through the source bus line 12 and applying an alternating rectangular wave of 10 V to the counter electrode 32 of the counter substrate 30. Furthermore, an alternating rectangular wave of 10 V opposite in polarity to the counter electrode 32 was applied to the Cs bus line 22. Thus, a voltage of approximately 20 V is applied to the liquid crystal layer 40 between the Cs bus line 22 and the counter electrode 32, and a voltage of approximately 10 V is applied between the Cs bus line 22 and the pixel electrode 24.

Immediately after the voltages were applied, a splay-to-bend transition occurred in each pixel 10 under observation, and after a short time, the whole screen came into bend alignment. That is, all the pixels 10 came into bend alignment. The duration of the splay-to-bend transition at −30° C. was approximately 2 seconds. This is considered to be because in the liquid crystal display device 1 according to the present embodiment the splay-to-bend transition surely occurred in the inclined portions 24B and 24C, which are step parts, and spread into each pixel 10.

Further, the optical characteristics of the liquid crystal display panel 2 produced by the above method were evaluated by the same method as described above.

As a result, since the whole screen came into bend alignment as described above, such a combination of the liquid crystal cell with the wave plates as described above allowed a black state to be observed from an oblique angle, whereby wider viewing angles were achieved. Furthermore, it was confirmed that even a quick switch in voltage between ON and OFF resulted in response at a high speed of not more than 200 msec even at −30° C. The terms “ON” and “OFF” here mean a relatively high voltage and a relatively low voltage and correspond to a black display and a white display, respectively. For example, 10 V was ON, and 2 V was OFF.

Further, FIG. 1 shows, in the cross-section of the liquid crystal display panel 2 thus produced, a state of alignment of those liquid crystal molecules 41 at the step parts (inclined portions) as observed when no voltage is applied.

In FIG. 1, θp is the pre-tilt angle of a liquid crystal molecule 41, and θk is the angle of inclination of the step portion (inclined portion 23B) of the insulating film 23. In the present example, the inclined portion 23B is equal in angle of inclination to the inclined portion 23C, and the step portions (inclined portions 24B and 24C) of the pixel electrode 24 and the step portions (inclined portion 25B and 25C) of the alignment film 25 are provided in such a way as to extend along the step portions (inclined portions 23B and 23C) of the insulating film 23. Therefore, the angle of inclination of the step portions (inclined portions 23B and 23C) of the insulating film 23, the angle of inclination of the step portions (inclined portions 24B and 24C) of the pixel electrode 24, and the angle of inclination of the step portions (inclined portions 25B and 25C) of the alignment film 25 are all equal to θk. In the present example, the liquid crystal display panel 2 was produced so that θp=8° and θk=45°.

As shown in FIG. 1, the alignment of liquid crystals in that region 40B in the liquid crystal layer 40 which is adjacent to the inclined portion 25B (inclined portions 23B and 24B), i.e., the alignment of liquid crystals in an area of overlap with the inclined portion 25B in a plan view (i.e., as viewed from a direction perpendicular to the substrate surfaces) is found to be anti-parallel alignment across the cell thickness of the liquid crystal layer 40, because the direction of inclination from a lower to higher part of the step portion ascends in a direction opposite to the rubbing direction and θk is greater than θp.

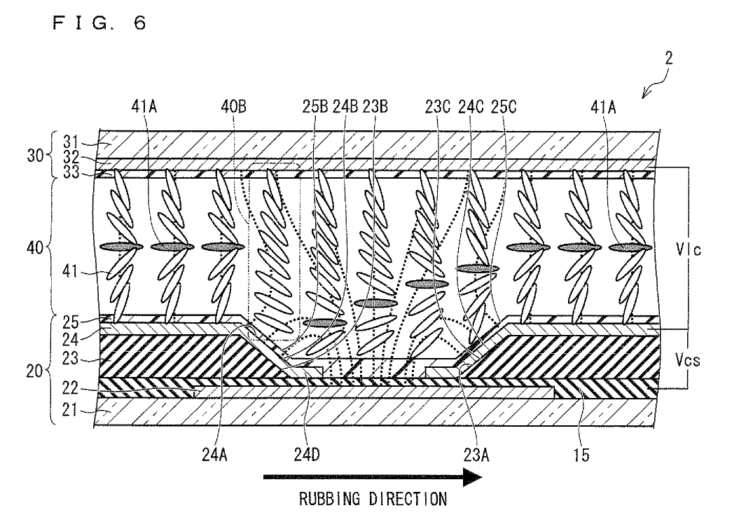

FIG. 6 is a cross-sectional view schematically showing the configuration of the liquid crystal display panel 2 in the liquid crystal display device 1 according to the present embodiment in the vicinity of the opening 24A provided in the area of overlap between the pixel electrode 24 and the Cs bus line 22 of the liquid crystal display panel 2, together with the alignment of liquid crystals as observed when a voltage is applied.

In the present embodiment, as shown in FIG. 6, a voltage Vcs is applied between the pixel electrode 24 and the Cs bus line 22, and a voltage V1c is applied between the pixel electrode 24 and the counter electrode 32.

As shown in FIG. 6, in flat parts of each pixel 10, i.e., in regions in each pixel 10 excluding the inclined planes (step portions) of the alignment film 25 of the TFT substrate 20, when a voltage is applied to the liquid crystal layer 40, those liquid crystal molecules 41 in the liquid crystal layer 40 which are closer to the upper or lower electrode (pixel electrode 24 or the counter electrode 32) in areas of overlap with these regions (flat parts) in a plan view rise, but those liquid crystal molecules 41 (indicated by hatching in FIG. 6) in the midsection of the liquid crystal layer 40 (hereinafter referred to as “liquid crystal molecules 41A” for convenience of explanation) cannot rise toward neither electrode and therefore remain parallel to the substrate surfaces.

However, in the step portion where the direction of inclination from a lower to higher part of the step ascends in a direction opposite to the rubbing direction or, more specifically, in that region 40B in the liquid crystal layer 40 which overlaps with the inclined portion 25B (inclined portions 23B and 24B), a transverse electric field is applied between the Cs bus line 22 and the pixel electrode 24 through the liquid crystal layer 40 in the vicinity of the opening 24A nearby. Therefore, both the force of the transverse electric field and the force of the electric field between the pixel electrode 24 and the counter electrode 32 act on those liquid crystals whose alignment is greatly inclined by the step (step portion) of the insulating film 23, i.e., those liquid crystal molecules 41 (alignment of liquid crystals) in anti-parallel alignment in the step portion (region 40B), so that the liquid crystal molecules 41A do not emerge as parallel to the substrate surfaces and therefore can rise smoothly across the cell thickness. In the present embodiment, such alignment of liquid crystals in a step portion inclined in a direction opposite to the rubbing direction becomes the nucleus of a splay-to-bend transition, whereby the splay-to-bend transition spreads across the whole of each pixel 10.

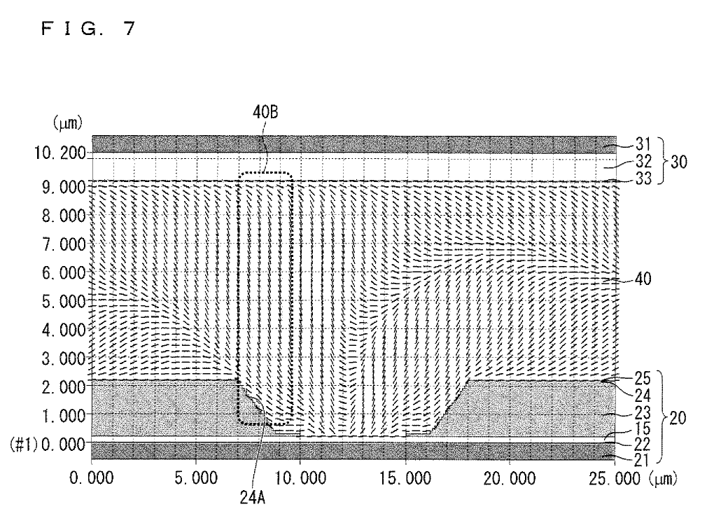

FIG. 7 shows a result of a calculation of a potential indicating a state of alignment of the liquid crystal molecules 41 as observed when a voltage is applied to the pixel electrode 24, the bus line, and the counter electrode 32 with use of simulation software (“LCD Master” produced by SHINTECH, Inc.).

From the state of alignment shown in FIG. 7, it is found that in the step portion (region 40B) where the direction of inclination from a lower to higher part of the step ascends in a direction opposite to the rubbing direction, those liquid crystal molecules 41A parallel to the substrate surfaces do not emerge, but those liquid crystal molecules 41A in anti-parallel alignment rise smoothly across the cell thickness.

According to the present embodiment, as described above, it is believed that as shown in FIGS. 1 and 7, a transverse electric field is applied between the Cs bus line 22 and the pixel electrode 24 through the liquid crystal layer 40 in the vicinity of the opening 24A and the transverse electric field acts on the step portion (region 40B) where the direction of inclination from a lower to higher part of the step ascends in a direction opposite to the rubbing direction, whereby bend alignment tends to take place.

Furthermore, since the openings 23A and 24A in the insulating film 23 and pixel electrode 24 are produced within the pixel 10 as described above, the direction of inclination from a lower to higher part of the step is a direction opposite to the rubbing direction in any of the step portions (inclined portions) of the insulating film 23 and the pixel electrode 24, regardless of the rubbing direction. For this reason, the configuration is so high in degree of freedom of rubbing direction that a alignment transition from the initial state (splay alignment) to the image display state (bend alignment or π twist alignment) in the liquid crystal layer 40 can be made quickly regardless of the rubbing direction.

Furthermore, the formation of the openings 23A and 24A in the insulating film 23 and pixel electrode 24 on the Cs bus line 22 makes it possible to suppress leakage of light even if splay alignment occurs in the vicinity of the opening 24A in the pixel electrode 24. Further, the step portion serves as a stopper to bring about an advantage of being able to prevent splay alignment from spreading to the display region in the pixel 10.

Although the Example of Manufacture assumes that the shapes of the openings 23A and 24A are rectangular, the shapes of the openings 23A and 24A are not limited to this.

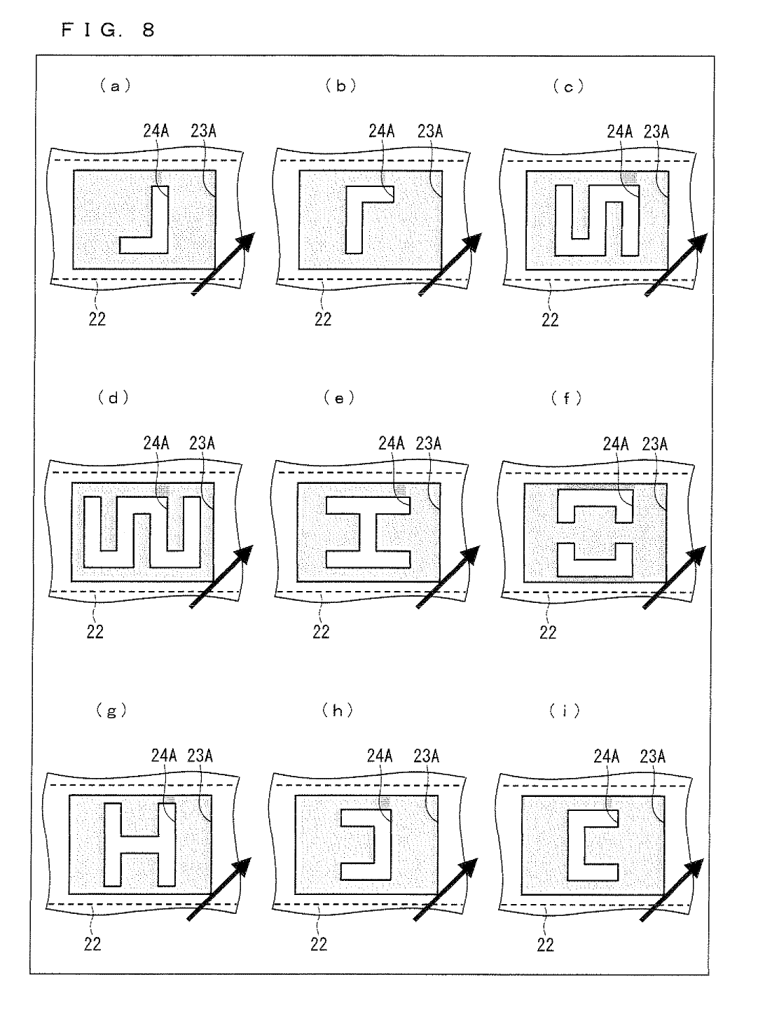

FIG. 8 includes plan views (a) through (i) each schematically showing an example of the shapes of the openings 23A and 24A in the TFT substrate 20. As the shapes of the openings 23A and 24A, such various patterns as shown in (a) through (i) of FIG. 8 can be adopted. Specifically, for example, the opening 24A may be configured to include a plurality of linear portions extending in directions intersecting with each other, and can take various shapes such as the shape of the letter V, the shape of the letter W, the shape of the letter X, and the shape of a polygon, as well as the shape of the letter L and the shape of a concavity in a plan view. Among them, from the point of view of the aperture ratio, it is preferable that the shapes of the openings 23A and 24 or, in particular, the shape of the opening 23A be in such a pattern as shown in (a) or (b) of FIG. 8.

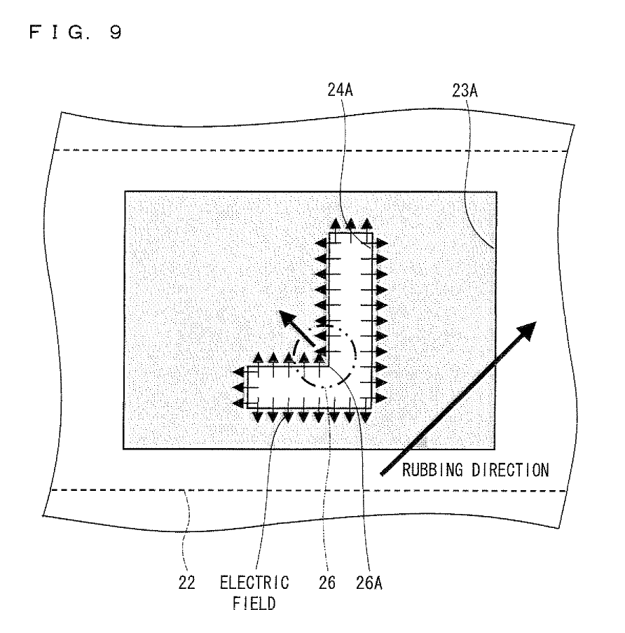

FIG. 9 shows an electric field that is generated in the opening 23A in the insulating film 23 from the Cs bus line 22 to the pixel electrode 24 through the opening 24A in the pixel electrode 24, with the electric field indicated by small arrows.

In the region 26 where the heads of small arrows get together as shown in FIG. 9, a large electric field is concentrated. That is, because as shown in FIG. 9 the opening 24A has at least one bent portion 26A where two domains different in electric field direction run into each other, two types of domain are generated at a short distance from each other around the bent portion 26A, whereby a large electric field is concentrated in the bent portion 26A and its surrounding region (region 26).

Furthermore, as shown in FIG. 9, the average direction of the arrows in the region 26A is orthogonal to the rubbing direction. For this reason, the force of torsion of the liquid crystal molecules 42 acts on the bent portion 26A and its surrounding region (region 26). It is believed that such a region 26 is likely to become the nucleus of a splay-to-bend transition, and that bend alignment is very likely to take place there.

That is, for example, by configuring the opening 24A to be shaped such that electric fields can be applied to the liquid crystal layer 40 in two directions, two types of twist alignment region, namely counterclockwise and clockwise twist alignment regions, are formed. In a place of contact between these twist alignment regions, elastic strain energy increases; therefore, a transition in state of alignment of the liquid crystal layer 40 is made more smoothly.

(a) through (i) of FIG. 8 shows various patterns in which an electric field is concentrated as above and the average direction of a region in which the electric field is concentrated is orthogonal to the rubbing direction, and any such pattern as these brings about the same effects, and is believed to bring about a better result (i.e., a bend nucleus is more likely to be generated in the bent portion of the opening 24A, and bend alignment is more likely to take place there) than does the pattern shown above in FIG. 2.

### Comparative Example 1

For comparison, the following shows a result of evaluation of (i) the splay-to-bend transition characteristics of a liquid crystal cell of a comparative liquid crystal display panel including a TFT substrate having no interlayer insulating film provided between a bus line and a pixel electrode (i.e., a TFT substrate having no such step portion as described above) and (ii) the optical characteristics of the comparative liquid crystal display panel.

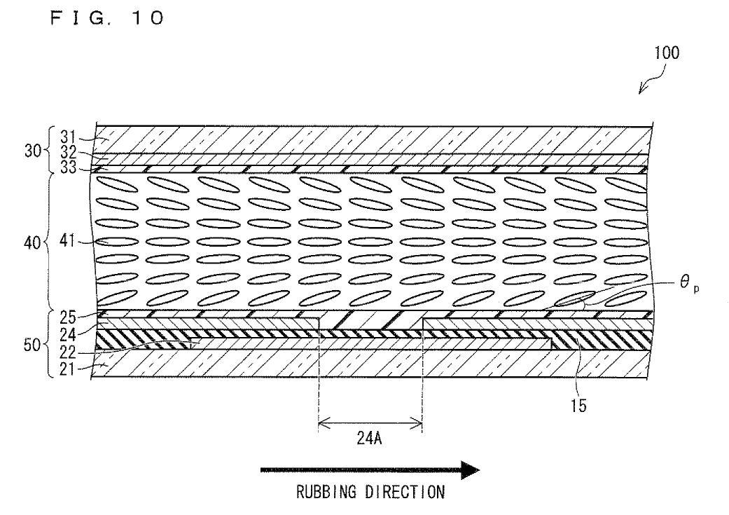

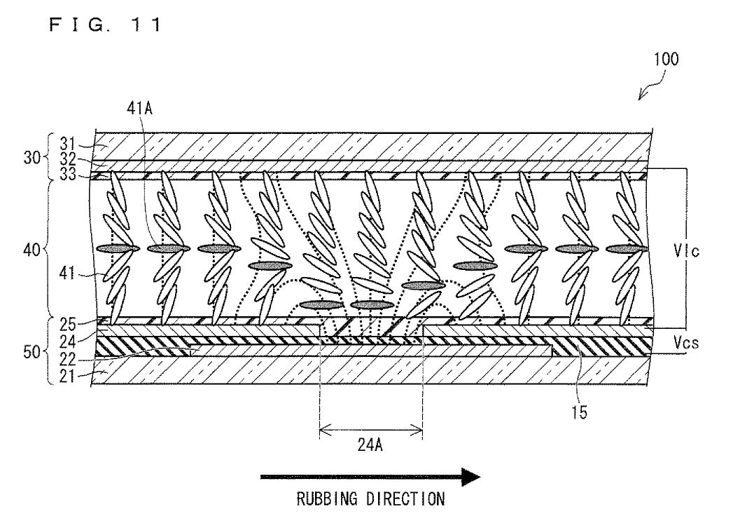

FIG. 10 is a cross-sectional view schematically showing the configuration of a comparative liquid crystal display panel in the vicinity of an opening provided in an area of overlap between a pixel electrode and a storage capacitor bus line of the comparative liquid crystal display panel, together with the alignment of liquid crystals as observed when no voltage is applied, the comparative liquid crystal display device including a TFT substrate having no interlayer insulating film provided between the bus line and the pixel electrode. FIG. 11 is a cross-sectional view schematically showing the configuration of the comparative liquid crystal display panel of FIG. 10 in the vicinity of the opening provided in the area of overlap between the pixel electrode and the storage capacitor bus line of the comparative liquid crystal display panel, together with the alignment of liquid crystals as observed when a voltage is applied. The same elements as those in FIGS. 1 and 2 are given the same reference numerals and are not described below.

In the present comparative example, a comparative liquid crystal display panel 100 was produced in the same manner as the liquid crystal display panel 2 except that a TFT substrate 50, shown in FIGS. 10 and 11, which has no insulating film 23 serving as an interlayer insulating film between a bus line and a pixel electrode 24 was used in place of the TFT substrate 20 of FIGS. 1 and 2.

Since the liquid crystal display panel 100 of FIGS. 10 and 11 has no insulating film 23 serving as an interlayer insulating film between a bus line and a pixel electrode 24, there is no step in the vicinity of the opening 24A in the pixel electrode 24. For this reason, θk is smaller than θp, so that the liquid crystals are not aligned anti-parallel across the cell thickness of the liquid crystal layer 40 as shown in FIG. 1.

As a result of observation of the splay-to-bend transition characteristics of a liquid crystal cell by applying a voltage of 10 V to the liquid crystal display layer 40 of the liquid crystal display panel 100 produced by the above method and applying a voltage of 10 opposite in polarity to the liquid crystal layer 40 between the Cs bus line 22 and the pixel electrode 24, it was found that there existed a large number of pixels where no splay-to-bend transition takes place after two seconds at −30° C., whereby pixels that do not make a bend transition were left behind. When viewed from an oblique angle, such a pixel was observed as a bright dot because of its difference in retardation.

As shown in FIG. 11, the liquid crystal display panel 100 has no step of the insulating film 23 (step of the interlayer insulating film 23) near the opening 24A in the pixel electrode 24. Therefore, such anti-parallel alignment as shown in FIG. 1 did not take place, but those liquid crystal molecules 41A remaining parallel to the substrate surfaces (those liquid crystal molecules 41 indicated by hatching) emerged in every place within the pixel. For this reason, it is believed that no splay-to-bend transition took place in many of the pixels of the liquid crystal display panel 100. The pixels where no transition nucleus was generated must wait for the spread of bend alignment from another pixel where a splay-to-bend transition took place, and therefore is believed to be unable to make a bend transition in such a short time of 2 seconds at such an extremely low temperature of −30° C. Such a pixel persisted throughout the duration of a display and never made a bend transition.

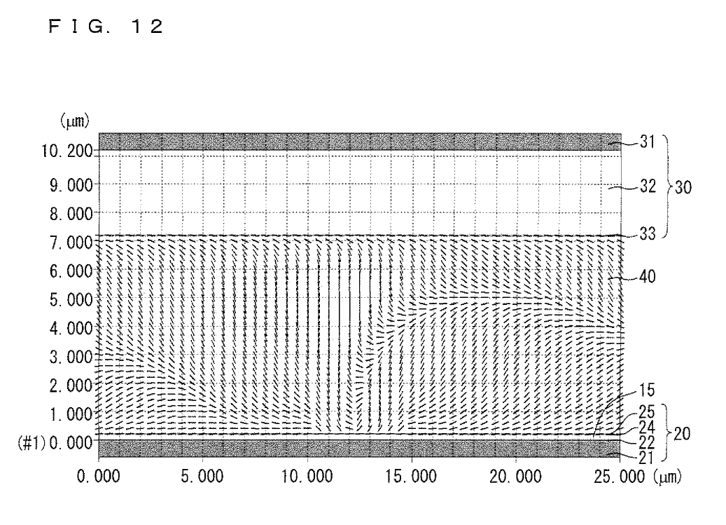

FIG. 12 shows a result of a calculation of a potential indicating a state of alignment of the liquid crystal molecules 41 as observed when a voltage is applied to the pixel electrode 24, bus line, and counter electrode 32 of the liquid crystal display panel 100 with use of the simulation software.

From the state of alignment shown in FIG. 12, it is found that even when the voltage is applied to the liquid crystal display panel 100, those liquid crystal molecules 41A parallel to the substrate surfaces emerge across the whole pixel and are unlikely to make a bend transition.

### Comparative Example 2

For comparison, the following shows a result of evaluation of (i) the splay-to-bend transition characteristics of a liquid crystal cell of a comparative liquid crystal display panel including a TFT substrate having no opening provided in a pixel electrode and (ii) the optical characteristics of the comparative liquid crystal display panel.

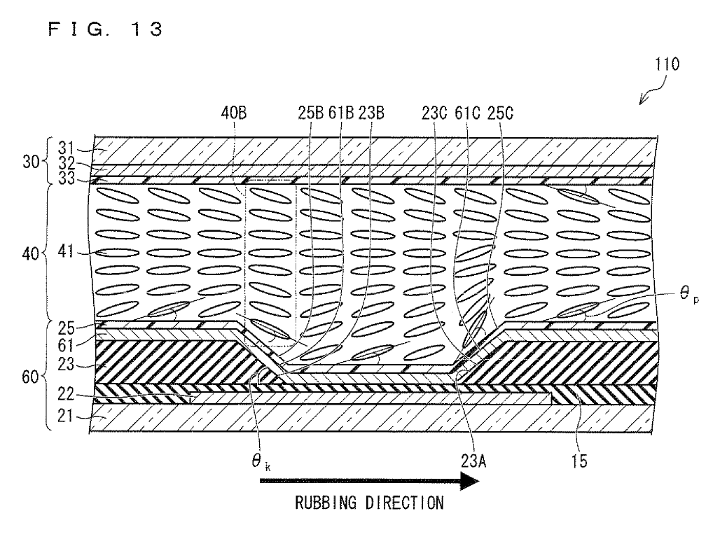

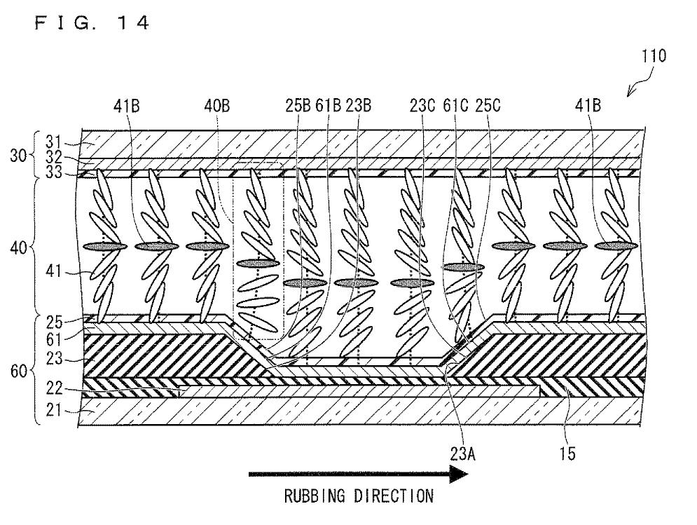

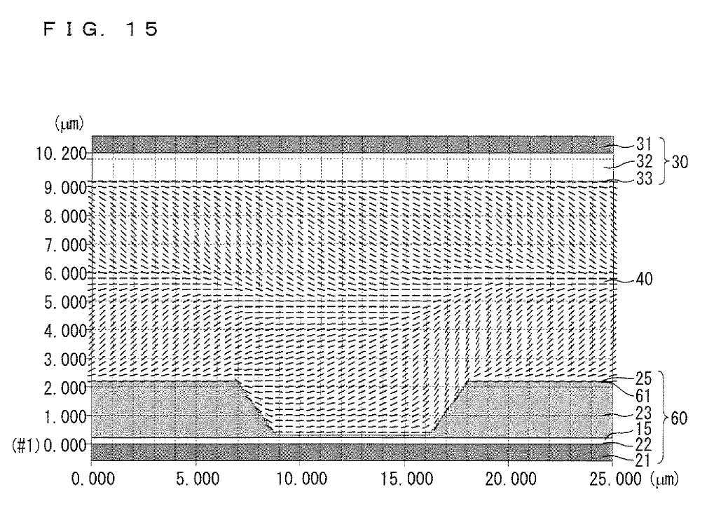

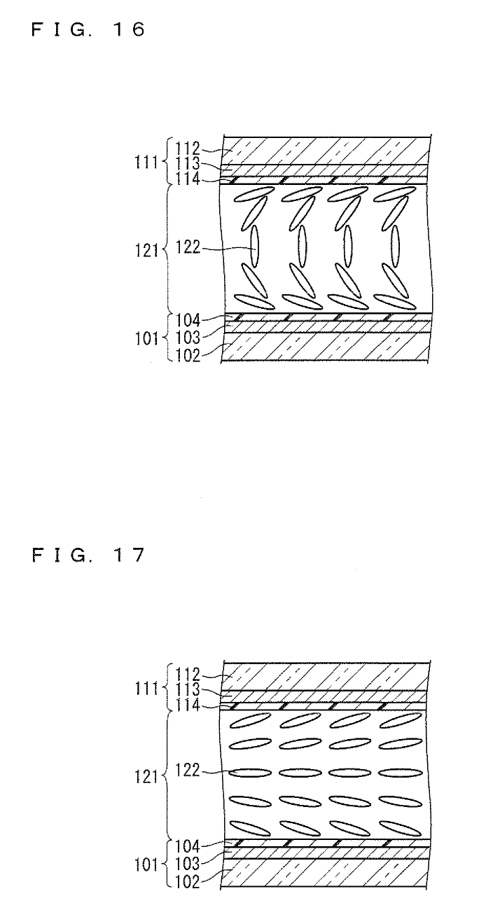

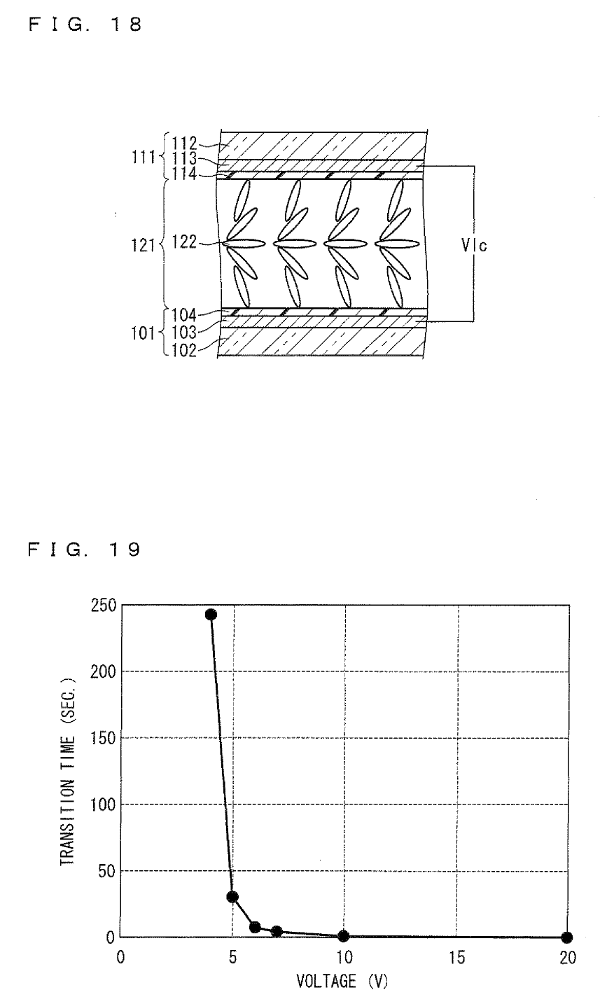

FIG. 13 is a cross-sectional view schematically showing the configuration of a comparative liquid crystal display panel in the vicinity of an opening provided in an area of overlap between a pixel electrode and a storage capacitor bus line of the comparative liquid crystal display panel, together with the alignment of liquid crystals as observed when no voltage is applied, the comparative liquid crystal display device including a TFT substrate having no opening provided in the pixel electrode. FIG. 14 is a cross-sectional view schematically showing the configuration of the comparative liquid crystal display panel of FIG. 13 in the vicinity of the opening provided in the area of overlap between the pixel electrode and the storage capacitor bus line of the comparative liquid crystal display panel, together with the alignment of liquid crystals as observed when a voltage is applied. The same elements as those in FIGS. 1 and 2 are given the same reference numerals and are not described below.

In the present comparative example, as shown in FIGS. 13 and 14, a comparative liquid crystal display panel 110 was produced in the same manner as the liquid crystal display panel 2 by using, in place of the TFT substrate 20 of FIGS. 1 and 2, a TFT substrate 60 configured in the same manner as the TFT substrate 20 except that a pixel electrode 61 provided with no opening is provided in place of each pixel electrode 24 provided with an opening 24A.

That is, since the liquid crystal display panel 110 has step portions (inclined portions 23B and 23C) provided by making the opening 23A in the insulating film 23 serving as an interlayer insulating film, the pixel electrode 61 and the alignment film 25 have step portions (inclined portions 61B and 61C and inclined portions 25B and 25C) equal in angle of inclination to the step portions (inclined portions 23B and 23C).

As a result of observation of the splay-to-bend transition characteristics of a liquid crystal cell by applying a voltage of 10 V to the liquid crystal display layer 40 of the liquid crystal display panel 110 produced by the above method and applying a voltage of 10 V opposite in polarity to the liquid crystal layer 40 between the Cs bus line 22 and the pixel electrode 61, it was found that there were almost no pixels where a splay-to-bend transition took place even after passage of two seconds at −30° C. When viewed from an oblique angle, such a pixel was observed as a completely different display because of its difference in retardation.

As shown in FIG. 13, the liquid crystal display panel 110 has no opening in the pixel electrode 61 near the step portions (inclined portions 23B and 23C) of the insulating film 23. Therefore, no such transverse electric field from the Cs bus line as shown in FIG. 1 is generated, nor is a transverse electric field through the liquid crystal layer 40 applied between the Cs bus line 22 and the pixel electrode 61. For this reason, as shown in FIG. 14, those liquid crystal molecules 41A remaining parallel to the substrate surfaces (those liquid crystal molecules 41 indicated by hatching) emerged in every place within the pixel. For this reason, it is believed that there was hardly any splay-to-bend transition nucleus generated in the liquid crystal display panel 110 and most of the pixels across the whole screen were unable to make a bend transition. Such a pixel persisted throughout the duration of a display and never made a bend transition.

FIG. 15 shows a result of a calculation of a potential indicating a state of alignment of the liquid crystal molecules 41 as observed when a voltage is applied to the pixel electrode 61, bus line, and counter electrode 32 of the liquid crystal display panel 110 with use of the simulation software.

From the state of alignment shown in FIG. 15, it is found that even when the voltage is applied to the liquid crystal display panel 110, those liquid crystal molecules 41A parallel to the substrate surfaces emerge across the whole pixel and are unlikely to make a bend transition.

### Comparative Example 3

For comparison, the following shows a result of evaluation of (i) the splay-to-bend transition characteristics of a liquid crystal cell of the liquid crystal display panel 2 of FIGS. 1 and 2, in which the distance between the end of the opening 24A to the step portion was made longer than the cell thickness (8 μm) by causing the width 24d of the fringe portion 24D (i.e., the distance between the end of the opening 24A in the pixel electrode 24 to the end of the opening 23A of the insulating film 23) to be 20 μm, and (ii) the optical characteristics of the comparative liquid crystal display panel.

That is, in the present comparative example, a comparative liquid crystal display panel was produced in the same manner as the liquid crystal display panel 2 except that the width 24d of the fringe portion 24D was changed as described above in the liquid crystal display panel 2 of FIGS. 1 and 2.

As a result of observation of the splay-to-bend transition characteristics of a liquid crystal cell by applying a voltage of 10 V to the liquid crystal display layer 40 of the liquid crystal display panel 110 thus produced and applying a voltage of 10 opposite in polarity to the liquid crystal layer 40 between the Cs bus line 22 and the pixel electrode 24, it was found that there were almost no pixels where a splay-to-bend transition took place even after passage of thirty seconds at −30° C. When viewed from an oblique angle, such a pixel was observed as a completely different display because of its difference in retardation.

This is considered to be because as shown in FIG. 1 the comparative liquid crystal display panel has the step portion (inclined portion 23B) of the insulating film 23 not near the opening 24A in the pixel electrode but in a place farther than the cell thickness and therefore such a transverse electric field from the Cs bus line 22 as shown in FIG. 1 no longer exerts an influence as far as the step portion. For this reason, it is believed that there was hardly any splay-to-bend transition nucleus generated and most of the pixels across the whole screen were unable to make a bend transition. Such a pixel persisted throughout the duration of a display and never made a bend transition.

The above result shows that the emergence of those liquid crystal molecules 41 parallel to the substrate surfaces is prevented by including, in a region corresponding to each pixel 10 in the TFT substrate 20, a region to which a transverse electric field parallel to the substrate surfaces is applied and providing, in that region, a region where the liquid crystal molecules 41 come into anti-parallel alignment, and a splay-to-bent transition can spread across the whole pixel 10 with the anti-parallel alignment of liquid crystal molecules 41 serving as a transition nucleus, with the result that the alignment transition from the initial state (splay alignment) to the image display state (bend alignment or π twist alignment) in the liquid crystal layer 40 can be made quickly even at such an extremely low temperature of −30° C.

On the other hand, when the region where the liquid crystal molecules 41 come into anti-parallel alignment is not provided in the region to which a transverse electric field parallel to the substrate surfaces is applied, i.e., when as shown in Comparative Examples 1 to 3 the region where the liquid crystal molecules 41 come into anti-parallel alignment is not provided, or even when the region where the liquid crystal molecules 41 come into anti-parallel alignment is provided, the effects of the present invention cannot be obtained if either of the following conditions is not satisfied: (i) a transverse electric field parallel to the substrate surfaces is applied in the first place; and (ii) the transverse electric field is applied to the region where the liquid crystal molecules 41 come into anti-parallel alignment.

In the present embodiment, as described above, whether those liquid crystal molecules 41 at the step portion are in anti-parallel alignment or not is confirmed by calculating a potential with use of simulation software. However, the state of alignment of the liquid crystal molecules 41 can be actually confirmed by a direct method, not by means of simulation. This method is described below.

First, in order to specify the alignment direction of a substrate treated with rubbing, the two substrates joined to each other (cell) are disassembled, and a new cell is produced from a substrate finished in advance with alignment treatment such as rubbing and one of the substrates disassembled from the older cell.

Next, as the angle at which the two substrates of the newly produced cell are joined is varied, the two substrates coincide in alignment direction (parallel alignment or anti-parallel alignment) with each other. Then, the two substrates take an extinction position under crossed nicols (i.e., the polarization axis of one of the substrates coincides with the rubbing direction).

Furthermore, a distinction between parallel alignment and anti-parallel alignment can be made by applying a voltage between the two substrates and microscopically observing a flat part (part other than the area around the step portion) within each pixel. Thus, when the flat part within each pixel is in parallel alignment and therefore in splay alignment, a splay-to-bend transition takes place. Meanwhile, when the parallel alignment in the flat part within each pixel is anti-parallel alignment, a splay-to-bend transition does not take place. In this way, the distinction between parallel alignment and anti-parallel alignment can be made. Further, the pre-tilt angle of the liquid crystal molecules 41 is found by measuring the pre-tilt angle after joining (i) one of the substrates disassembled from the older cell to (ii) a substrate coated with an alignment film whose pre-tilt angle is known in advance so that anti-parallel alignment is attained. Furthermore, the angle of inclination of the step portion is found by directly measuring the shape of the step with a contact step measuring instrument or the like. The above method gives the alignment direction, the pre-tilt angle, and the angle and direction of the step of the step portion, thus making it possible to confirm directly, not by means of simulation, that the alignment of liquid crystals at the step portion is anti-parallel alignment.

Although the liquid crystal display panel 2 of FIGS. 1 and 2 is configured such that the pixel electrode 24 covers the whole surface of the peripheral wall, which is the inclined plane (step portion) of the insulating film 23, of the opening 23A, the present embodiment is not limited to this. The liquid crystal display panel 2 of FIGS. 1 and 2 may be configured such that the pixel electrode 24 covers at least a part of the inclined plane (inclined portion 23B) of the insulating film 23, as long as the region where the liquid crystal molecules 41 come into anti-parallel alignment when a voltage is applied is provided in the region to which a transverse electric field parallel to the substrate surfaces is applied.

Further, although in the present embodiment, as described above, the insulating film 23 having the inclined portion 23B (step portion) elevated in a direction opposite to the rubbing direction is provided between the Cs bus line 22 and the pixel electrode 24 so that an inclined plane inclined in a direction opposite to the pre-tilt direction of the liquid crystal molecules 41 is provided so as to bring the liquid crystal molecules 41 into anti-parallel alignment, the present invention is not limited to this.

The pre-tilt direction and pre-tilt angle of the liquid crystal molecules 41 are controlled by the alignment films 25 and 33 provided in contact with the liquid crystal layer 40.

In the present embodiment, as described above, the step portions (inclined planes) are provided in the pixel electrode 24 and the alignment film 25 by providing the step portion (inclined plane) in the insulating film 23, and the pre-tilt angle and pre-tilt direction of the liquid crystal molecules 41 are controlled by subjecting the alignment films 25 and 33 to rubbing treatment. However, the rubbing treatment is not necessarily needed. Instead, the pre-tilt angle and pre-tilt direction of the liquid crystal molecules 41 can be changed locally, for example, with ultraviolet irradiation.

Further, it is possible to bring the liquid crystal molecules 41 locally into anti-parallel alignment, for example, by either forming a minute projection (protrusion; not shown, which projects across the thickness of the liquid crystal layer 40) or performing oblique evaporation of silicon oxide (SiO) or ultraviolet irradiation inside of or in the vicinity of the opening 24A, without the need to provide the inclined plane in the insulating film 23 as described above, and to apply a transverse electric field to the region where the liquid crystal molecules 41 are in anti-parallel alignment.

That is, according to the present embodiment, by partially providing, inside of or in the vicinity of the opening 24A, a region where the liquid crystal molecules 41 are in anti-parallel alignment, the liquid crystal molecules 41 in anti-parallel alignment can be made to be a transition nucleus of bend alignment.

As the method for partially changing the alignment direction of the liquid crystal molecules 41 as described above, a method described in Patent Literature 3 can be employed, for example. In Patent Literature 3, the alignment direction of the liquid crystal molecules 41 is partially changed 90 degrees, for example. In the present embodiment, the liquid crystal molecules 41 can be partially brought into anti-parallel alignment in the liquid crystal layer 40 by partially changing the alignment direction of the liquid crystal molecules 41 180 degrees through the same process.

Further, as the method for forming a minute projection on the substrate, such a conventionally well-known method as described in Patent Literature 1 can be employed. In Patent Literature 1, a minute projection is formed in each pixel with use of aluminum or silicon nitride. According to the present embodiment, by forming a minute projection inside of or in the vicinity of the opening 24A in the same manner as in Patent Literature 1, the liquid crystal molecules 41 in the region provided with the minute projection can be made to be a transition nucleus of bend alignment.

The following provides a more specific explanation of the method for bringing the liquid crystal molecules 41 partially into anti-parallel alignment as described above.

As mentioned above, the pre-tilt direction (in other words, the alignment control direction of each substrate, i.e., the alignment treatment direction of the alignment films 25 and 33) and pre-tilt angle of the liquid crystal molecules 41 are controlled by the alignment films 25 and 33 provided in contact with the liquid crystal layer 40, and the pre-tilt direction of the liquid crystal molecules 41 is controlled by alignment treatment such as rubbing treatment of the alignment films 25 and 33. In the liquid crystal display panel 2 of FIG. 1, the alignment films 25 and 33 are rubbed in one direction (first direction) across their entire surfaces. Therefore, those liquid crystal molecules 41 in the vicinity of the alignment film 25 or 33 are aligned parallel to the first direction, i.e., the rubbing direction, except for those liquid crystal molecules 41 in anti-parallel alignment at the inclined portion 25B.

Therefore, in order to bring the liquid crystal molecules partially into anti-parallel alignment by partially changing the pre-tilt direction of the liquid crystal molecules 41, it is only necessary, for example, to provide the alignment film 25 with a region rubbed in the first direction and a region rubbed in a second direction opposite to the first direction and thereby control the pre-tilt direction of those liquid crystal molecules 41 in the first-direction rubbed region to be the first direction and control the pre-tilt direction of those liquid crystal molecules 41 in the second-direction rubbed region to be the second direction.

For this purpose, first, the alignment films 25 and 33 are formed, for example, from polyimide on the pixel electrode 24 and the counter electrode 25, respectively, and the alignment films 25 and 33 are rubbed in the first direction across substantially their entire surfaces. After that, the alignment film 25 is masked, and the region where the liquid crystal molecules 41 are brought into anti-parallel alignment (hereinafter sometimes referred to simply as “anti-parallel region”) is exposed; then, the region thus exposed is rubbed in the second direction opposite to the first direction. This makes it possible to provide the alignment film 25 with the region rubbed in the first direction and, the region rubbed in the second direction opposite to the first direction.

Further, another example of the method is as follows: The alignment films 25 and 33 are formed, for example, from polyvinyl cinnamate (PVCi) as optical alignment films on the pixel electrode 24 and the counter electrode 25, respectively, and the alignment films 25 and 33 are rubbed in the first direction across substantially their entire surfaces. After that, the anti-parallel region in the alignment film 25 is irradiated with deep UV (at a wavelength of 254 nm). This method makes it possible to control the pre-tilt direction in the alignment film 25 by adjusting the direction of the polarized light with which the anti-parallel region in the alignment film 25 is irradiated.

Still another example of the method is as follows: the alignment films 25 and 33 are formed on the pixel electrode and the counter electrode 25, respectively, and the alignment films 25 and 33 are rubbed in the first direction across substantially their entire surfaces. After that, a positive photoresist is applied onto the alignment film 25. After pre-baking, the photoresist is irradiated with UV via a photomask and immersed in a developer. After that, the photoresist is fixed by post-baking. In this step, a predetermined region that becomes an anti-parallel region is selectively exposed and rubbed in the second direction opposite to the first direction, and then the photoresist is removed. This makes it possible to partially change the alignment direction of the liquid crystal molecules 41 180 degrees.

Further, as the minute projection (protrusion), various protrusions such as a raised portion or spacer made of silicon nitride or the like and having a tapered shape can be provided, for example, as in Patent Literature 1. The minute projection is not particularly limited in size or shape. The tapered shape of the raised portion makes it possible to effectively enhance the pre-tilt.

Further, the same effects can be obtained by using a depressed portion having a tapered shape, instead of using a raised portion having a tapered shape.

As described above, according to the present embodiment, it is possible to bring the liquid crystal molecules 41 partially into anti-parallel alignment, for example, by either forming a minute projection (not shown) or performing oblique evaporation of silicon oxide (SiO) or ultraviolet irradiation inside of or in the vicinity of the opening 24A, instead of providing, between the Cs bus line 22 and the pixel electrode, the inclined portion 23B (step portion) elevated in a direction opposite to the rubbing direction, and to apply a transverse electric field to the region where the liquid crystal molecules 24 are in anti-parallel alignment. This also allows the whole of each pixel 10 to make a quick alignment transition with the anti-parallel alignment of liquid crystal molecules serving as a nucleus.

However, among these methods, the above-mentioned method by which the insulating film 23 having the inclined portion 23B (step portion) elevated in a direction opposite to the rubbing direction is provided between the Cs bus line 22 and the pixel electrode 24 is more preferable, because the method makes it possible to form a transition nucleus of bend alignment even in the case of alignment treatment uniform across the whole of each pixel 10. Provision of such an insulating film 23 having an inclined portion 23B makes it possible to simplify the manufacturing process, reduce the number of steps, and reduce manufacturing costs, in comparison with a partial change in alignment direction, pre-tilt angle, or the like of the liquid crystal molecules 41 with ultraviolet irradiation or the like. Further, there is an advantage of brining about a new effect while using rubbing treatment, which is a conventional technique widespread commonly.

Further, although the present embodiment has been described above by way of example where a bend transition based on the anti-parallel alignment of liquid crystal molecules 41 as a bend nucleus is generated by applying a transverse electric field between the Cs bus line 22 and the pixel electrode 24, overlapped with the Cs bus line 22 via the insulating film 23, through the liquid crystal layer 40, the present embodiment is not limited to this.

The present embodiment includes, as electric field applying means for applying a transverse electric field to those liquid crystal molecules 41 brought into anti-parallel alignment, two layers of electrode provided on different planes with an insulating film sandwiched therebetween, i.e., a first electrode and second electrode, provided closer to the liquid crystal layer than the first electrode, which has a region overlapped with the first electrode via the insulating film. Among the two layers of electrode, the electrode closer to the liquid crystal layer has an opening provided in an area of overlap with the other electrode via the insulating film, and as long as the electrodes are configured to be different in potential, the first electrode and the second electrode are not limited to the Cs bus line 22 and the pixel electrode 24.

The two layers of electrode may be constituted, for example, by a gate bus line 11 or a source bus line 12 and a pixel electrode 24 adjacent thereto. Alternatively, in order to apply, to the liquid crystal molecules 41, a voltage of not less than a threshold voltage required for a bend transition, it is possible to place a wire between adjacent pixel electrodes 24 and thereby apply a transverse electric field between the wire and the pixel electrodes 24. Further, in this case, in order to form the nucleus (transition nucleus) of a bend transition by concentrating an electric field, it is possible to cause a part of each end of each pixel electrode 24 to project toward a gate bus line 11 or a source bus line 12 to overlap with the bus line, and to provide a plurality of notched portions in a region where the pixel electrode 24 overlaps with the gate bus line 11 or the source bus line 12. Application of a transition voltage to such a liquid crystal display panel 2 leads to an increase in potential difference across the thickness of the liquid crystal display panel 2 and concentration of a strong electric field around the notched portions. The concentration of the electric field makes it possible to surely make a splay-to-bend transition and display an image of good quality free from point defects.

Further, such electric field applying means only needs to be provided on at least either the TFT substrate 20 or the counter substrate 30.

In either case, according to the present embodiment, application of a voltage larger than a splay-to-bend critical voltage to the liquid crystal layer 40 causes the anti-parallel alignment of liquid crystal molecules 41 to act as a transition nucleus. This allows each pixel to make a reliable and quick alignment transition (esp., a splay-to-bend transition) from an initial state (splay alignment) to an image display state (bend alignment or π twist alignment, which is a more stable state).

As described above, the liquid crystal display panel is a liquid crystal display panel including a pair of substrates placed opposite each other via a liquid crystal layer containing liquid crystal molecules that, when an electric field is applied, makes an alignment transition from an initial state to an image display state different in state of alignment from the initial state, in that region of at least either of the pair of substrates to which a transverse electric field parallel to the substrate is applied, a region where the liquid crystal molecules come into anti-parallel alignment (i.e., align themselves in a direction parallel and opposite to a pre-tilt direction of the liquid crystal molecules, i.e., to a direction of alignment treatment of the substrate) being provided.

According to the foregoing configuration, the region where the liquid crystal molecules come into anti-parallel alignment is provided in that region of at least either of the pair of substrates to which a transverse electric field parallel to the substrate is applied; therefore, there appear no liquid crystal molecules parallel to a substrate surface of the substrate, whereby the alignment transition (esp., a splay-to-bend transition) from the initial state (splay alignment) to the image display state (bend alignment or π twist alignment, which is a more stable state) in the liquid crystal layer spreads across the whole of each pixel with the anti-parallel alignment of liquid crystal molecules serving as a transition nucleus. Therefore, the alignment transition can be made quickly even at such an extremely low temperature of −30° C. Thus, the foregoing configuration makes it possible to provide a liquid crystal display panel capable of causing each pixel to surely make an alignment transition and making a quick alignment transition from an initial state to an image display state in a liquid crystal layer.

It should be noted that there is less of an energy barrier between π twist alignment and bend alignment. It has already been known conventionally that as long as there is a transition from splay alignment to either π twist alignment or bend alignment, all regions are brought into bend alignment by carrying out display driving and become capable of a display.

The liquid crystal display panel is preferably configured to further include: a first electrode; and a second electrode, provided closer to the liquid crystal layer than the first electrode, which has a region overlapped with the first electrode via an insulating film, the first and second electrode being provided on at least either of the pair of substrates, wherein: the insulating film includes a step portion, provided in an area of overlap between the first electrode and the second electrode, which has an inclined plane inclined in a direction opposite to a pre-tilt direction of the liquid crystal molecules and which brings the liquid crystal molecules partially into anti-parallel alignment; and the second electrode covers at least a part of the inclined plane and includes an opening provided in an area of overlap with the first electrode so that a transverse electric field is applied from the first electrode to the second electrode.

According to the foregoing configuration, a transverse electric field can be made to act on the inclined plane from the opening through the liquid crystal layer, and the alignment of liquid crystals at the inclined plane becomes anti-parallel alignment. Therefore, according to the foregoing configuration, the alignment transition from the initial state (splay alignment) to the image display state (bend alignment or π twist alignment, which is a more stable state) in the liquid crystal layer spreads across the whole of each pixel with the anti-parallel alignment of liquid crystal molecules at the inclined plane serving as a transition nucleus. Therefore, the alignment transition from the initial state to the image display state can be made quickly even at such an extremely low temperature of −30° C.

In this case, it is preferable that: that substrate which has the first electrode and the second electrode be finished with rubbing treatment; and the inclined plane be inclined in such a way as to be elevated in a direction opposite to a rubbing direction of the substrate.

The region where the liquid crystal molecules come into anti-parallel alignment can be provided at the inclined plane of the insulating film by using various methods such as forming a minute projection (protrusion) or performing oblique evaporation of silicon oxide (SiO) or ultraviolet irradiation inside of or in the vicinity of the opening, instead of providing, as the inclined plane, an inclined plane inclined in such a way as to be elevated in a direction opposite to a rubbing direction of the substrate as described above.

However, such provision as the inclined plane of an inclined plane inclined in such a way as to be elevated in a direction opposite to a rubbing direction of the substrate makes it possible to form a transition nucleus of bend alignment even in the case of alignment treatment uniform across the whole of each pixel, and makes it possible to simplify the manufacturing process, reduce the number of steps, and reduce manufacturing costs, in comparison with the case of a partial change in alignment direction, pre-tilt angle, or the like of the liquid crystal molecules with ultraviolet irradiation or the like. Further, there is an advantage of brining about a new effect while using rubbing treatment, which is a conventional technique widespread commonly.

Further, the liquid crystal display panel is preferably configured such that the inclined plane has an angle of inclination larger than a pre-tilt angle of the liquid crystal molecules.

Since the angle of inclination of the inclined plane is larger than the pre-tilt angle of the liquid crystals, it is easy for the alignment of liquid crystals to be anti-parallel alignment, and it becomes likely for a transition nucleus to be generated. Therefore, the alignment transition from the initial state (splay alignment) to the image display state (bend alignment or π twist alignment, which is a more stable state) in the liquid crystal layer can be surely made. For this reason, a quick alignment transition can be made.

Further, because the inclined plane is located at a distance shorter than the thickness of the liquid crystal layer from the opening, a transverse electric field acts on the inclined plane when a voltage is applied to the first electrode and the second electrode, which makes it easy for the alignment of liquid crystals to be anti-parallel alignment and likely for a transition nucleus to be generated. Therefore, the alignment transition from the initial state (splay alignment) to the image display state (bend alignment or π twist alignment, which is a more stable state) in the liquid crystal layer can be surely made. That is, because the region where the liquid crystal molecules come into anti-parallel alignment is located at a distance shorter than the thickness of the liquid crystal layer from an end of the opening, a transverse electric field can be surely made to act on the inclined plane from the opening through the liquid crystal layer, and the alignment transition can be surely made with the anti-parallel alignment of liquid crystal molecules serving as a nucleus.

Further, it is preferable that the second electrode have a flat portion provided between the opening and the inclined plane.

Such provision of the flat portion of the second electrode between the opening and the inclined plane, i.e., the provision of the flat portion of the second electrode at the lower part of the inclined plane eliminates the need to separately make, in another region inside of the pixel (i.e., a region other than the opening), a contact hole conductive to the higher part of the inclined plane. For this reason, a high aperture ratio can be secured.

The liquid crystal display panel is preferably configured such that the first and second electrodes provided on either of the pair of substrates are a storage capacitor bus line (storage capacitor electrode) and a pixel electrode, respectively.

According to the foregoing configuration, the foregoing configuration can be easily realized without great design variation, and the pixel potential can be stabilized by a storage capacitance that is formed between the storage capacitor bus line and the pixel electrode.

Further, since the flat portion of the pixel electrode is provided as the flat portion of the second electrode between the opening and the inclined plane, a high aperture ratio can be secured.

Furthermore, as described above, the formation of the opening on the storage capacitor bus line serving as the first electrode makes it possible to suppress leakage of light even if splay alignment occurs in the vicinity of the opening in the pixel electrode. Furthermore, the step portion serves as a stopper to bring about an advantage of being able to prevent splay alignment from spreading to the display region inside of the pixel.

Further, as described above, the liquid crystal display device is configured to include such a liquid crystal display panel as described above.

Since the liquid crystal display device include such a liquid crystal display panel as described above, there appear no liquid crystal molecules parallel to a substrate surface of the liquid crystal display panel, whereby the alignment transition (esp., a splay-to-bend transition) from the initial state (splay alignment) to the image display state (bend alignment or π twist alignment, which is a more stable state) in the liquid crystal layer spreads across the whole of each pixel with the anti-parallel alignment of liquid crystal molecules serving as a transition nucleus. Therefore, the alignment transition can be made quickly even at such an extremely low temperature of −30° C. Thus, the foregoing configuration makes it possible to provide a liquid crystal display device capable of causing each pixel to surely make an alignment transition and making a quick alignment transition from an initial state to an image display state in a liquid crystal layer.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

A liquid crystal display panel and a liquid crystal display device of the present invention can cause each pixel to surely make an alignment transition and can make a quick transition from an initial state to an image display state in a liquid crystal layer, and as such, can be widely applied, for example, to image display apparatuses such as televisions and monitors and image display apparatuses that are provided in office automation equipment such as word processors and personal computers or information terminals such as video cameras, digital cameras, and cellular phones.

1. A liquid crystal display panel comprising a pair of substrates placed opposite each other via a liquid crystal layer containing liquid crystal molecules that, when an electric field is applied, makes an alignment transition from an initial state to an image display state different in state of alignment from the initial state,
in that region of at least either of the pair of substrates to which a transverse electric field parallel to the substrate is applied, a region where the liquid crystal molecules come into anti-parallel alignment being provided.

2. The liquid crystal display panel as set forth in claim 1, further comprising:
a first electrode; and
a second electrode, provided closer to the liquid crystal layer than the first electrode, which has a region overlapped with the first electrode via an insulating film,
the first and second electrode being provided on at least either of the pair of substrates, wherein:
the insulating film includes a step portion, provided in an area of overlap between the first electrode and the second electrode, which has an inclined plane inclined in a direction opposite to a pre-tilt direction of the liquid crystal molecules and which brings the liquid crystal molecules partially into anti-parallel alignment; and
the second electrode covers at least a part of the inclined plane and includes an opening provided in an area of overlap with the first electrode so that a transverse electric field is applied from the first electrode to the second electrode.

3. The liquid crystal display panel as set forth in claim 2, wherein:
that substrate which has the first electrode and the second electrode is finished with rubbing treatment; and
the inclined plane is inclined in such a way as to be elevated in a direction opposite to a rubbing direction of the substrate.

4. The liquid crystal display panel as set forth in claim 2, wherein the inclined plane has an angle of inclination larger than a pre-tilt angle of the liquid crystal molecules.

5. The liquid crystal display panel as set forth in claim 2, wherein the region where the liquid crystal molecules come into anti-parallel alignment is located at a distance shorter than a thickness of the liquid crystal layer from an end of the opening.

6. The liquid crystal display panel as set forth in claim 2, wherein the second electrode has a flat portion provided between the opening and the inclined plane.

7. The liquid crystal display panel as set forth in claim 2, wherein the first and second electrodes provided on either of the pair of substrates are a storage capacitor bus line and a pixel electrode, respectively.

8. A liquid crystal display device comprising a liquid crystal display panel as set forth in claim 1.
